(19) United States
(12) Patent Application Publication
(10) Pub. No.: US 2015/0284061 A1
(43) Pub. Date: Oct. 8, 2015

(54) HAZARDOUS-ENVIRONMENTAL DIVING SYSTEMS

(71) Applicant: PARAGON SPACE DEVELOPMENT CORPORATION, Tucson, AZ (US)

(72) Inventors: Grant A. Anderson, Tucson, AZ (US); Taber K. MacCallum, Tucson, AZ (US); Sebastian A. Padilla, Tucson, AZ (US); Chad E. Bower, Littleton, CO (US)

(21) Appl. No.: 14/553,907

(22) Filed: Nov. 25, 2014

Related U.S. Application Data
(60) Provisional application No. 61/932,641, filed on Jan. 28, 2014.
(60) Provisional application No. 61/909,260, filed on Nov. 26, 2013.

(51) Int. Cl. B63C 11/20; B63C 11/04; A62B 18/10; B63C 11/12; B63C 11/14; B63C 11/02; B63C 11/08

(52) U.S. Cl. CPC B63C 11/202; B63C 11/02; B63C 11/04; B63C 11/08; B63C 11/12; B63C 11/14; A62B 18/10; B63C 2011/043; B63C 2011/182

(57) ABSTRACT

This disclosure provides a protective diving system for isolating a diver from a hazardous diving environment. The protective diving system can include a dry suit system including a dry suit and a surface exhaust valve coupled to the dry suit, and a return-surface exhaust assembly configured to exhaust gas from the dry suit system to a breathable atmosphere outside of the diving environment of the diver. The surface exhaust valve is configured to receive gas from the dry suit and exhaust gas to the return-surface exhaust assembly without exhausting to the surrounding diving environment. The protective diving system can further include one or more chemically-resistant components, where the chemically-resistant components include a fluoroelastomer.

### PRIORITY CLAIM

This application claims priority to U.S. Provisional Patent Application No. 61/932,641 filed Jan. 28, 2014 and entitled “Hazardous-Environmental Diving Systems,” and to U.S. Provisional Patent Application No. 61/909,260 filed Nov. 26, 2013 and entitled “Hazardous-Environmental Diving Systems,” all of which are hereby incorporated by reference in their entirety and for all purposes.

### STATEMENT REGARDING FEDERALLY SPONSORED RESEARCH OR DEVELOPMENT

Some embodiments of this invention were developed with United States Government Support under N00024-04-C-4017 and N00024-14-C-4061 awarded by the Naval Sea Systems Command.

### TECHNICAL FIELD

This disclosure relates to protective diving systems, and more particularly to protective diving systems designed to improve diver safety in high-risk environments.

### BACKGROUND

Military, professional, and other occupational divers are frequently exposed to contaminated waters in the course of carrying out routine duties, as well as in operations arising from acts of terrorism, accidents, disaster recovery operations, and more. During recovery from a terrorist attack, such as on the USS Cole, dive operations after a shipwreck or aircraft wreck often necessitate dive operations in mixtures of water and jet fuel, hydraulic fluid, fuel oils, and/or other contaminants.

Conventional diving equipment is not adequately designed to protect a diver from exposure to various contaminants in the water. Many dive environments can be so hazardous that existing diving equipment can deteriorate to the point of failure in a matter of minutes, especially when exposed to contaminants such as diesel oil. This exposes the diver to hazardous chemicals and compounds with adverse health effects, as well as threatening operation of the very equipment on which the diver's life and health depends. Chemical warfare agent contamination, biological warfare agents, and disease from pollution such as sewage in harbors are also of special concern. Even low agent concentrations in the water can be, in effect, amplified by high pressure and full immersion conditions experienced by the diver.

In addition to the immediate dangers from terrorism, accidents, and disaster recovery operations, divers are frequently exposed to contaminated water in the course of carrying out routine duties. Divers can be at risk from chronic exposure to contaminated waters in harbors, ports, and waterways. Studies have shown that naval divers with multiple exposures to waterborne carcinogens are two times more likely to contract cancer than control populations.

Efforts to help in rescue and cleanup operations in Louisiana following Hurricane Katrina further highlighted problems related to lack of adequate dive equipment, such as lack of “chemically-hardened” dive equipment. Since industry-standard dive equipment were insufficient in protecting against chemically contaminated waters, divers working in the region reported delays to critical diving operations while evaluations of water conditions were completed.

Industry standard dive helmets, such as the popular Kirby-Morgan MK-21 equipped with double exhaust valves, failed to prevent intrusion of water and aerosols when the diver exhaled or when the diver's head moved from an upright position at any operational depth.

### SUMMARY

The systems, methods and devices of this disclosure each have several innovative aspects, no single one of which is solely responsible for the desirable attributes disclosed herein.

One innovative aspect of the subject matter described in this disclosure can be implemented in a protective diving system for isolating a diver operating in a diving environment. The system comprises a dive helmet system that includes a dive helmet, and a dry suit system that includes a dry suit and a surface exhaust valve coupled to the dry suit. One or more components of the dry suit system include a fluoroelastomer. The system further comprises a return-surface exhaust assembly configured to exhaust gas from one or both of the dive helmet system and the dry suit system to a breathable atmosphere outside of the diving environment of the diver, where the surface exhaust valve is configured to receive gas from the dry suit and exhaust gas to the return-surface exhaust assembly.

In some implementations, one or more components of the dive helmet system include a fluoroelastomer. In some implementations, the return-surface exhaust assembly includes a surface-return hose to exhaust the gas to the breathable atmosphere and a demand exhaust regulator, where the demand exhaust regulator includes a valve assembly for controlling the flow of the gas from one or both of the dive helmet system and the dry suit system to the surface-return hose. In some implementations, the valve assembly includes an exhaust diaphragm that is movable between a flow-blocking position to block passage of the gas to the surface-return hose and a flow-delivery position to enable passage of the gas to the surface-return hose. In some implementations, valve assembly can be configured to control the flow of the gas on demand to maintain a substantially static equilibrium pressure within the dive helmet. In some implementations, one or both of the dry suit and the surface exhaust valve includes one or more sealants, the one or more sealants including a fluoroelastomer.

Another innovative aspect of the subject matter described in this disclosure can be implemented in a return-surface exhaust dry suit assembly system for isolating a diver operating in a diving environment. The system comprises a surface exhaust valve for coupling to a dry suit for the diver, where the surface exhaust valve includes an inlet port for receiving gas from the dry suit and an exhaust port for exhausting the gas. The system further comprises a return umbilical coupled to the exhaust port and a return-surface exhaust assembly coupled to the return umbilical and configured to exhaust the gas to a breathable atmosphere outside of the diving environment of the diver, where at least one of the surface exhaust valve, the return umbilical, and the return-surface exhaust assembly includes a fluoroelastomer.

In some implementations, the gas is exhausted through the return-surface exhaust assembly without exhausting the gas to the diving environment. In some implementations, the return-surface exhaust assembly includes a surface-return hose to exhaust the gas to the breathable atmosphere, and a demand exhaust regulator including a valve assembly for controlling the flow of the gas from the dry suit to the surface-return hose. In some implementations, the valve assembly includes an exhaust diaphragm that is movable between a flow-blocking position to block passage of the gas to the surface-return hose and a flow-delivery position to enable passage of the gas to the surface-return hose. In some implementations, the surface exhaust valve is configured to maintain a buoyancy of the diver by controlling the release of air from the dry suit to the return-surface exhaust assembly. In some implementations, at least one of the surface exhaust valve, the return umbilical, and the return-surface exhaust assembly includes one or more sealants, the one or more sealants including a fluoroelastomer.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram illustrating an example hazardous-environmental dive system including a helmet and a dry suit system designed to enhance diver safety.

FIG. 1B shows a schematic diagram illustrating an example helmet system designed to enhance diver safety.

FIG. 1C shows a schematic diagram illustrating an example dry suit system designed to enhance diver safety.

FIG. 2 shows a perspective view of an example dive helmet with a return surface exhaust (RSE) assembly.

FIG. 3 shows an exploded perspective view illustrating components of an example dive helmet.

FIG. 4 shows a perspective view illustrating components of an RSE assembly.

FIG. 5 shows an exploded perspective view of a demand exhaust regulator (DER) component.

FIG. 6A shows a perspective cross-sectional view of a DER component.

FIG. 6B shows a top view of a valve seat of the DER component of FIG. 6A.

FIG. 6C shows a cross-sectional view through section 6C-6C of FIG. 6B illustrating arrangements of the valve seat of FIG. 6B.

FIG. 7 shows a perspective view of a valve body of a DER component.

FIG. 8 shows a top view of the valve body of FIG. 7.

FIG. 9 shows a cross-sectional view of the valve body of FIG. 8 through section 9-9 of FIG. 8.

FIG. 10A shows a cross-sectional view through section X-X of FIG. 3 illustrating an emergency dump valve in normal operating configuration.

FIG. 10B shows a cross-sectional view through section X-X of FIG. 3 illustrating the emergency dump valve in an emergency configuration.

FIG. 11A shows a side view of an example emergency dump valve.

FIG. 11B shows an exploded perspective view illustrating components of the emergency dump valve of FIG. 11A.

FIG. 11C shows a cross-sectional view through section 11C-11C of FIG. 11A of the emergency dump valve of FIG. 11A.

FIG. 12 shows a perspective view illustrating an example dive helmet and dive suit including a hazardous-environmental modification assembly.

FIG. 13 shows a side view of a dive helmet including a side block valve assembly including a connector for coupling the side block valve assembly to an inflation hose of a dry suit system.

FIG. 14A shows a perspective view of an example surface exhaust valve for a dry suit system.

FIG. 14B shows an exploded perspective view of components of the surface exhaust valve of FIG. 14A.

FIG. 14C shows a cross-sectional view of the surface exhaust valve of FIG. 14A.

FIG. 14D shows a cross-sectional view of the surface exhaust valve of FIG. 14A upon opening the valve by pressing a purge button.

FIG. 14E shows a cross-sectional view of the surface exhaust valve of FIG. 14A upon opening the valve by a pressure differential.

FIG. 15 shows a schematic diagram illustrating air flow through a surface supplied and regulated surface exhaust system.

FIG. 16 shows a schematic diagram illustrating an example surface-return assembly.

FIG. 17 shows a perspective view of an example tender station for a dive system.

FIG. 18 shows a flow diagram illustrating an example method of using a retrofitted underwater dive system.

FIG. 19 shows a flow diagram illustrating an example method of retrofitting an existing underwater dive system.

FIG. 20 shows a perspective view illustrating an example “factory-hardened” dive helmet to enhance diver safety.

Like reference numbers and designations in the various drawings indicate like elements.

### DETAILED DESCRIPTION

The present disclosure provides systems, apparatuses, devices, and methods for a protective diving system for isolating a diver from a diving environment. Conventional diving systems can include a dive helmet and a dry suit, where an air supply may be received by the dive helmet to facilitate breathing and where an air supply may be received by the dive suit for pressure and flotation control. The air supply can provide a flow of gas to the diver and the gas may be exhausted by one or more in-water exhaust valves into the surrounding environment. Even though the diving system may be equipped with one or more filters, such in-water exhaust valves and systems can leave a pathway for aerosols, fumes, particulates, and contaminants to get back into the dive helmet and dry suit.

Additionally, conventional diving systems may be made up of one or more components that are vulnerable to chemical attack by hazardous materials and vulnerable to permeation by hazardous materials into the dive helmet and/or dry suit. Examples of such components that may be vulnerable include O-rings, seals, diaphragms, and gaskets. Other components, such as supply or return hoses, can be made of materials that are vulnerable to chemical degradation and permeation.

To protect and isolate the diver from the diving environment, a return-surface exhaust assembly can facilitate the exhaustion of gas to a breathable atmosphere outside of the diving environment, such as above the surface of the water. Typically, when a diver is hundreds of feet below the surface of the water, opening a valve to the surface of the water can create a tremendously powerful suction due to large differences in pressure. This amount of suction can exert an enormous amount of force pulling towards the surface of the water. Such force can be exerted on the diver, decompressing the dry suit, the dive helmet, and the diver. This can cause serious injury or even death to the diver. The present disclosure provides a protective diving system that can isolate the diving system from the diving environment and substantially limit the suction to only the gas that is expelled by the diver. The present disclosure further isolates the diving system from the diving environment by incorporating chemically resistant materials in one or more components of the diving system, where the one or more components can include fluoroelastomers.

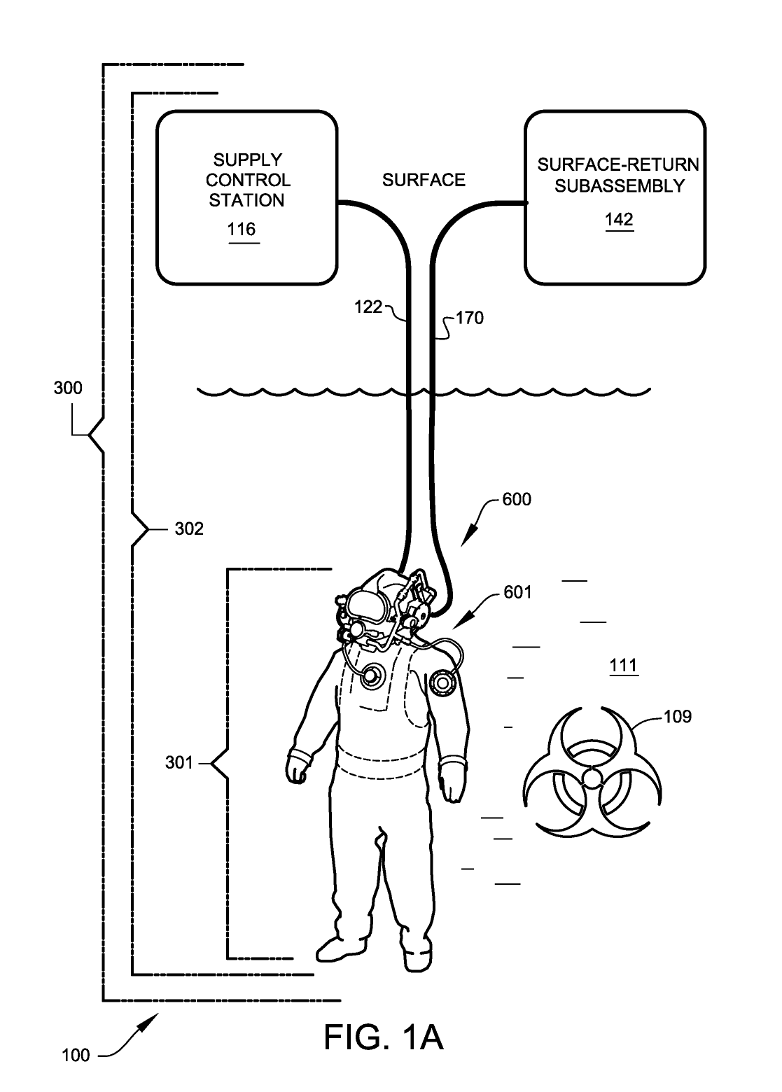

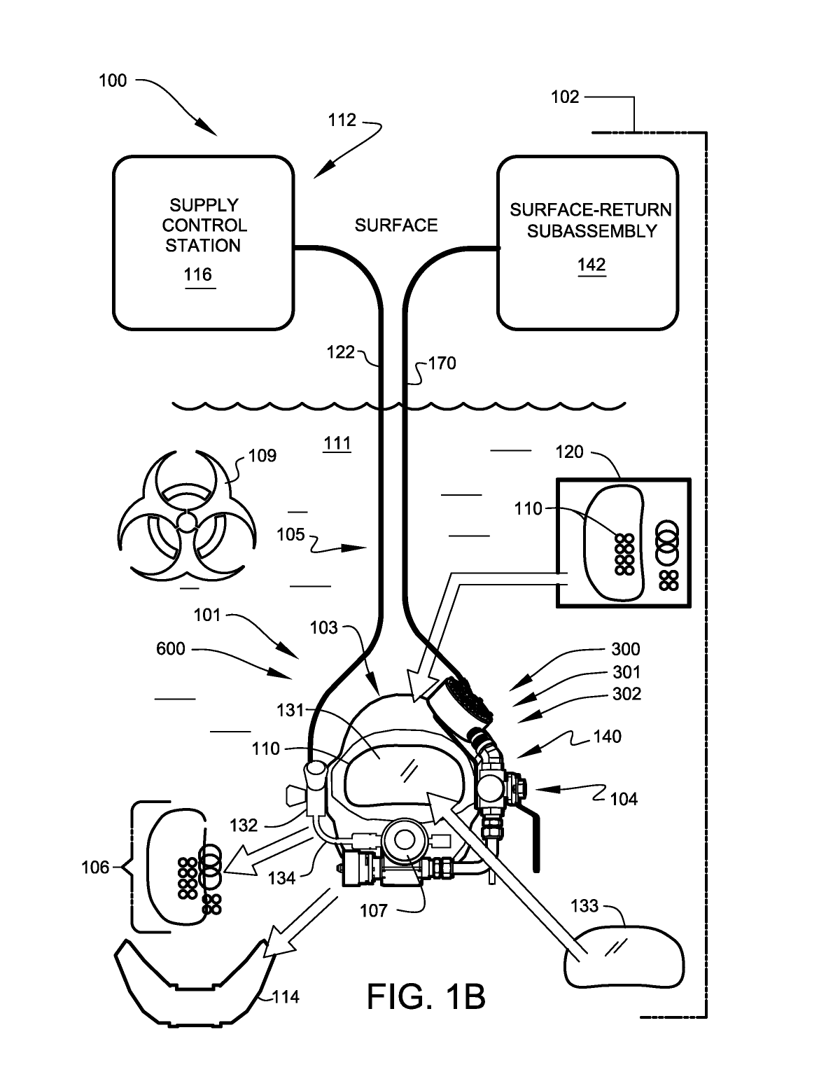

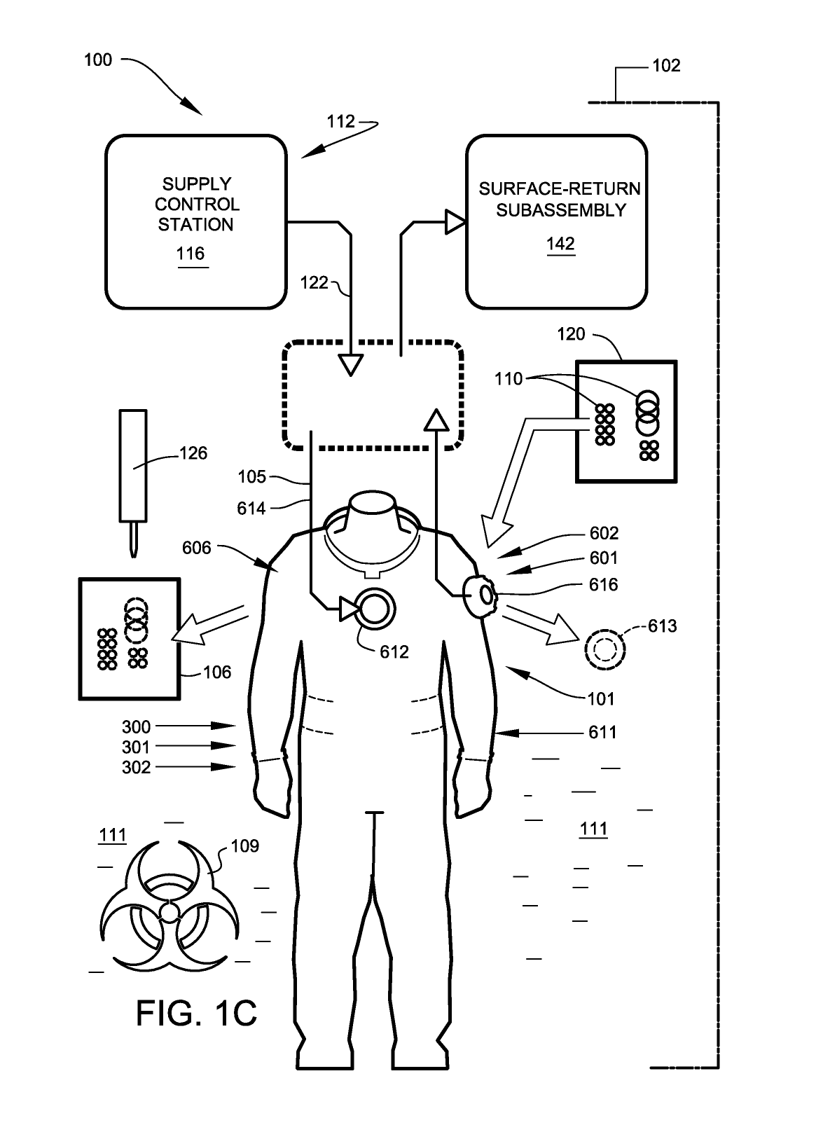

FIG. 1A shows a schematic diagram illustrating an example hazardous-environmental dive system including a helmet and a dry suit system designed to enhance diver safety. In FIG. 1A, a protective diving system 100 can include a helmet system 600 and a dry suit system 601, which have been adapted to increase diver safety in underwater diving operations. The helmet system 600 and the dry suit system 601 may be adapted for operating in waters or other diving environment 111 containing at least one hazardous material 109. In some implementations, the at least one hazardous material can include but is not limited to chemical agents that can be toxic to divers, such as jet fuel, marine diesel, hydraulic fluid, biological compounds, industrial chemicals, oils, acids, bases, bacteria, and chemical and biological warfare agents. The helmet system 600 and the dry suit system 601 may form a continuous barrier against the at least one hazardous material. In some implementations, the helmet system 600 and the dry suit system 601 can substantially reduce the ingress of the at least one hazardous material into the helmet system 600 and the dry suit system 601.

In FIG. 1A, a protective diving system 100 can include a hazardous material-hardened regulated surface exhaust diving system (HMRSEDS) 300. The HMRSEDS 300 can include a hazardous material-hardened diving system (HMDS) 301 and a regulated surface exhaust diving system (RSEDS) 302.

FIG. 1B shows a schematic diagram illustrating an example helmet system designed to enhance diver safety. FIG. 1C shows a schematic diagram illustrating an example dry suit system designed to enhance diver safety. The helmet system 600 and the dry suit system 601 can be part of the arrangement in HMRSEDS 300. The helmet system 600 and the dry suit system 601 can be designed to generate and maintain a fully-protected breathing environment. In other words, the protective diving system 100 can fully or at least substantially isolate the diver from the diving environment 111. The protective diving system 100 can incorporate contaminant-resistant materials and physical configurations to limit the intrusion of hazardous materials, thereby forming a continuous protective barrier around the diving environment 111 to limit the intrusion of the hazardous material 109.

In some implementations, the protective diving system 100 can include dive equipment that is “factory hardened” to include contaminant-resistant materials and physical configurations. The term “factory hardened” as used herein can refer to any device or apparatus supplied in ready-to-use form. In some implementations, the protective diving system 100 can be generated by applying one or more specific modifications to an existing underwater dive system 101. For example, a Hazardous Environmental Modification Assembly (HEMA) 120 can include a component-based kit system. The HEMA 120 can be adapted to implement one or more modifications to the existing underwater dive system 101.

Some parts of the present disclosure may describe retrofit modifications of an existing underwater dive system 101. Other parts of the present disclosure may describe an apparatus in a ready-to-use or factory hardened configuration. It is understood that some of the hardening features in the HEMA 120 may be implemented in factory hardened units. In some implementations, a majority of the structures and arrangements described with respect to HEMA 120 is applicable to factory-produced embodiments.

Those with ordinary skill in the art will appreciate that, under appropriate circumstances, other system arrangements such as, for example, applying each of the below-described modifications separately, may suffice for ensuring diver safety. Thus, some or all of the below-described modifications may be applied depending on a specific helmet or dry suit design or depending on the severity of an operational hazard or depending on other conditions. Each of the below-described modifications can be enabled by the HEMA 120 and may be installable by end users of underwater diving systems.

The helmet system 600 can include a dive helmet 103 and the dry suit system 601 can include a dry suit 611. The HEMA 120 may be used to convert a commercially available dive helmet 103 and a dry suit 611 to form an improved protective diving system 100 that substantially isolates the diver from hazardous materials 109 in the diving environment 111. In some implementations, the improved protective diving system 100 can provide broad resistance to chemicals that may be found in diving environments 111 following accidents (e.g., waterway spills), acts of terrorism, disaster recovery operations, etc. Various fuels, oils, industrial chemicals, biological agents, acids, bases, and other chemical agents have been observed to degrade materials in typical dive helmets 103 and dry suits 611, resulting in leaks and other detrimental changes in the helmet and dry suit equipment and their components.

A variety of hazardous materials 109 may be found within the diving environment 111, including chemicals, biological vectors, toxic industrial chemicals, toxic industrial materials (TIC/TIM), potential chemical warfare agents, and other contaminants. In some implementations, a low contaminant concentration in a breathing air system can result in high partial pressures of the contaminant at working depths of the diving environment 111. Thus, even small amounts of hazardous materials 109 in the water 111, such as jet fuel or other chemical agents, can be toxic to divers submerged at working depths. Implementations of the protective diving system 100 can remove or minimize any pathway in which the hazardous materials 109 can enter the helmet system 600 or the dry suit system 601. Implementations of the protective diving system 100 can modify existing underwater dive system 101 to ensure maintenance of a safe breathing environment during an underwater operation, such as at least for one underwater operational duration.

In some implementations, the HEMA 120 can be a user-retrofittable kit designed to retrofit a diving apparatus, such as a surface-supplied diving apparatus. The surface-supplied diving apparatus may be identified as an existing underwater dive system 101 including helmet and/or dry suit systems. Typical existing underwater dive systems 101 are configured to supply breathing or inflation gas to the diver by way of a supply umbilical cord 105 and for the gas to be subsequently discharged directly into the surrounding diving environment 111. Hence, this occurs without a surface return. Such existing underwater dive systems 101 can include an existing dive helmet 103, an existing surface-supplied breathing gas subsystem 112, and an existing in-water exhaust component. The in-water exhaust component can be a helmet in-water exhaust subsystem 114, shown removed from the dive helmet 103 in FIG. 1B, or the in-water exhaust component can be a dry suit in-water exhaust valve 613, shown removed from the dry suit 611 in FIG. 1C.

The operational safety and performance deficiencies of an existing underwater dive system 101 can be identified and corrected with one or more modifications using the HEMA 120. The modifications can be risk-mitigating modifications designed to protect the diver from the intrusion of hazardous materials 109 into the breathing and/or dry suit environment of the diver for at least one predetermined operational duration.

A helmet system 600 or an existing underwater dive system 101 with modifications using the HEMA 120 can address one or more issues. One of the issues addressed by the helmet system 600 or the HEMA 120 can include movement of contaminants through material boundaries of the diver's environment. Another one of the issues addressed by the helmet system 600 or the HEMA 120 can include back contamination of aerosols, fumes, and particulates generated from in-water exhausting of gas from existing in-water exhaust subsystem 114 and/or dry suit in-water exhaust valve 613.

Common underwater dive systems 101 have been shown to not adequately protect divers against many common contaminants and solvents. Test simulations were designed for operational durations of not less than 6 hours. The test simulations identified multiple failure points caused by introduction of hazardous materials 109 into the diver's breathing environment. For example, permeability testing of existing second-stage regulator diaphragm of demand supply regulator 107 (and associated parts) showed a serious failure of silicone materials when exposed to low molecular weight constituents of Jet A fuel, among other contaminants. In a diesel-fueled environment, existing helmet systems experienced deterioration of diaphragms and O-rings within 5-15 minutes. Breakthrough of carcinogenic compounds into the diver's breathing environment was observed to occur substantially concurrently with such failures.

To improve existing underwater diving systems 101, materials are identified exhibiting resistance to chemical attack and resistance to permeability. Typical materials in existing underwater diving systems 101 can be vulnerable to direct chemical degradation. In some instances, some materials can exhibit satisfactory resistance to direct chemical attack but still allow for chemical migration through the composition, thus permitting a chemical pathway to compromise the diver's safety.

In some implementations, materials that can be susceptible to chemical attack and/or permeability can include existing soft-goods components 106 of the dive helmet 103, which can be similar to the soft-goods components 106 of the dry suit 611. This can include but is not limited to elastomeric (natural or synthetic rubber), O-rings, diaphragms, seals, gaskets, etc. As a result, the HEMA 120 or the improved protective diving system 100 can include one or more soft-goods replacement/improved parts for the soft (e.g., elastomeric) materials subjected to in-service contact with the hazardous materials 109.

Improved components 110 of soft-goods components 106 can include materials exhibiting relatively similar or equivalent mechanical characteristics to the original parts, with the added characteristic of resistance to chemical attack and low chemical permeability, thereby reducing degradation of the components and permeation of the hazardous materials 109 into the diver's breathing environment.

In some implementations, improved components 110 of soft-goods components 106 can replace existing Buna-N (nitrile rubber), neoprene, butyl, and silicon parts. Typically, a commercial dive helmet 103 and dry suit 611 can include a model-specific arrangement of existing soft-goods components 106. In some implementations, the improved components 110 can serve as replacements for equivalent “model-specific” set of components. For example, existing underwater dive systems can include a model 37 commercial dive helmet 103 produced by Kirby Morgan Dive Systems Inc. of Santa Maria, Calif. (see, e.g., FIG. 1B). Improved components 110 can be selected to match the size, quantity, and mechanical properties of existing soft-goods components 106 of this dive helmet 103. The model 37 commercial dive helmet 103 can include over two dozen O-rings, gaskets, and seals. Some or all of the existing soft-goods components 106 of the dive helmet 103 can be replaced by the improved components 110. Specific helmet data can be found by accessing the manufacturer's website.

The improved components 110 can be part of the HEMA 120. In some implementations, the improved components 110 can include elastomers of low chemical permeability, good outgassing characteristics, and appropriate mechanical properties. In addition, such elastomers can be hazardous-material-resistant compositions that are resistant to degraded physical performance by contact with the hazardous materials 109. Such elastomers can also be resistant to transmission of hazardous quantities of hazardous materials 109 into the breathing environment by permeation of hazardous materials 109 through such hazardous-material-resistant compositions. Moreover, such elastomers are able to maintain their integrity at extreme depths, such as about 198 feet of sea water (fsw) and below, and at extreme temperature ranges, such as between about −20° F. and about 160° F. In addition, such elastomers can maintain their integrity for long a long operational duration, such as about 6 hours or longer.

The improved components 110 can be made of a specific class of polymers having the improved characteristics described above. The class of polymers can include elastomeric materials having superior performance. In some implementations, the improved components 110 can include but is not limited a class of polymers based on fluorine chemistry. This can include fluorocarbon elastomers generally identified as fluoroelastomers (FKM). This can include solids of polytetrafluoroethylene (PTFE) or Teflon®, including PTFE-containing elastomers, based on fluorinated organic polymers having carbon-to-carbon linkages as the foundation of their molecular structures. These materials can exhibit high chemical resistance, suitable mechanical properties, and acceptable material cost. The aforementioned materials can exhibit substantially similar or superior mechanical properties of existing soft-goods components 106, thereby at least maintaining critical performance specifications within the diving equipment. Materials including a range of fluoroelastomer chemistries may be selected to align with required mechanical properties and/or chemical resistance requirements of specific improved components 110. Examples of improved components 110 having the fluoroelastomer chemistries can include O-rings, diaphragms, seal, and gaskets. Sealants, caulking, and coatings can be described below.

Typically, fluoroelastomer permeability can be inversely proportional to the fluorine content of the material. The chemical permeability can be inversely proportional to material cost. An example of a fluoroelastomer for lower-cost soft-goods material can include commercially available Viton® products produced DuPont Performance Elastomers L.L.C. of Wilmington, Del., which can be provided with the HEMA 120. Another example of a fluoroelastomer can include commercially produced Viton A, which can be included in a general purpose package.

In some implementations, a fluoroelastomer can include a high-performance soft-goods material such as the Kalrez® perfluoroelastomer, which is produced by DuPont Performance Elastomers L.L.C. Kalrez® perfluoroelastomer can demonstrate a lower permeability and degradation rate, but is typically a higher cost than Viton A. In an example of a testing simulation, a demand regulator diaphragm including Kalrez® had contributed only 12 parts per trillion of hydrocarbons the breathing gas when diving in pure Jet A after 1,125 hours of testing. While the cost of Kalrez® may be higher per installation, there is likely a reduced equipment rebuilding frequency that is anticipated to compensate for the added initial cost. Table A shows a list of example materials and material sources for improved components 110 of soft-goods components 106, which can be part of the HEMA 120.

Other fluorocarbon materials and fluoroelastomers that were tested include PTFE or Teflon®, Momentive®RFV1106, which may be used as a fluorosilicone sealant, and Viton®GLT 600S. Nevertheless, it will be understood by those of ordinary skill in the art that under appropriate circumstances, other fluoroelastomers may suffice, such as Xyfluor® (Green and Tweed), Dyneon® (by 3M), Nitrile, etc.

TABLE A

| Material | Material Source |
|---|---|
| Viton Sheet (diaphragm material, etc.) | DuPont Co. |
| Viton Sheet, custom molding, and other | AAA Acme Rubber Co. |
| extrusions | |
| Viton custom molded parts and O-ring | Parco Inc. |
| manufacturer | |
| Viton custom molded parts and O-ring | Simrit (Simrit USA) |
| manufacturer | |
| Fluoroelastomer caulks and sealants (used to | Pelseal ® Technologies, |
| seal joints in the dive helmets 103) | LLC |
| Krytox performance lubricants | DuPont Co. |
| PTFE | DuPont Co. |
| Viton ® GLT-600S fluoroelastomer (used as | DuPont Co. |
| a diaphragm material) | |
| FRV1106 fluorosilicone sealant | Momentive Performance |
| | Materials, Inc. |

In some commercial dive helmets 103, such as those produced by Kirby Morgan Dive Systems, Inc. of Santa Maria, Calif., an existing face-port lens 131 may be constructed of clear polycarbonate (see, e.g., FIG. 1B). The material has a moderate to high potential for contaminant-permeation and is easily damaged by contact with a number of different hazardous materials 109. In some implementations of the HEMA 120 or the protective diving system 100, a face-port lens 131 can include at least one hazardous-material-resistant material that is substantially resistant to degraded physical performance by contact with the hazardous material 109 and resistant to permeation of hazardous levels of hazardous material 109 into the diver's breathing environment. In some implementations, the HEMA 120 or the protective diving system 100 can include an optical-faceplate covering 133 made of such a hazardous-material-resistant material that can substantially cover existing face-port lens 131. The optical-faceplate cover 133 can have sufficient transparency as to maintain a level of optical viewing through the existing face-port lens 131. Sufficient transparency can include at least greater than 50% or at least greater than 70% transparency to visible light. In some implementations, the optical-faceplate covering 133 can include a sheet of glass or plastic material laminated over the exterior surface of the existing face-port lens 131.

A surface-supplied gas subsystem 112 can include a supply control station 116 and supply umbilical 105 as shown in FIGS. 1A-1C. The surface-supplied gas subsystem 112 can supply a breathing air supply to the diver. By way of an example, a typical supply umbilical 105 can include a ⅜″ gas supply hose 122, a ¼″ pneumofathometer hose, and a communication cable. Some components of the supply umbilical 105 may be vulnerable to a hazardous-material-caused failure, including components made of rubber or other synthetic compositions. Such components can include the existing gas supply hose 122. The gas supply hoses 122 can have a similar susceptibility to certain hazardous materials 109 as the soft-goods components 106 of dive helmets 103 and dry suit 611, including permeation of hydrocarbons in the breathing air supply.

In some implementations, the gas supply hose 122 of a protective diving system 100 can include a chemically-resistant material. In some implementations, the HEMA 120 can include a chemically-resistant hose covering 118 to cover an existing gas supply hose 122 of the supply umbilical 105. The chemically-resistant hose covering 118 can include a fluoroelastomer sheath 124 wrapped around the existing gas supply hose 122 and sealed with a fluoroelastomer sealant 126. The chemically resistant hose covering 118 or the gas supply hose 122 of the protective diving system 100 can maintain the functional and structural integrity of the supply umbilical 105 for an intended operational duration. It will be understood by those of ordinary skill in the art that under appropriate circumstances, considering issues such as cost, intended use, etc., other supply-hose arrangements, such as the use of umbilical hoses made of chemically-resistant fluoroelastomers, the use of other protective surface coatings may suffice.

The supply control station 116 may provide a control point for a topside operator (tender) and one or more surface-supported divers. The supply control station 116 can include provisions for the control of the supply of breathing gas, diver depth monitoring, and voice communications. In some implementations, the supply control station 116 may be located outside of the hazardous diving environment 111. For example, the supply control station 116 may be located at the surface of the water, in a diving bell, or in a submerged habitat within hazardous diving environment 111. The gas supplied by the supply umbilical 105 can include air or other gas mixtures, such as helium, oxygen, etc. An example of a commercially available supply control station 116 can include the Kirby Morgan model KMACS-5.

Accordingly, the dive helmet system 600 can include one or more components, where the one or more components include a fluoroelastomer. Moreover, the dry suit system can include one or more components, where the one or more components include a fluoroelastomer.

The HEMA 120 or the improved protective diving system 100 can reduce or otherwise eliminate back contamination of aerosols, fumes, and particulates entering from in-water exhausting of breathing gas. For example, such back contamination can result from existing in-water exhaust subsystem 114 of the diving helmet 103, as shown in FIG. 1B. Moreover, such back contamination can occur from in-water exhausting of gas from existing in-water exhaust valve 613 of dry suit 611. However, the protective diving system 100 does not include such in-water exhaust components, but includes a regulated surface exhaust (RSE) assembly for the helmet system 600 and the dry suit system 601. Accordingly, the protective diving system 100 includes one or both of a RSE helmet assembly 104 and a RSE dry suit assembly 602. In some implementations, the HEMA 120 can permit modification by removal of at least one of the in-water exhaust subsystem 114 and the in-water exhaust valve 613, and replacing them with the RSE helmet assembly 104 and/or the RSE dry suit assembly 602, as described below.

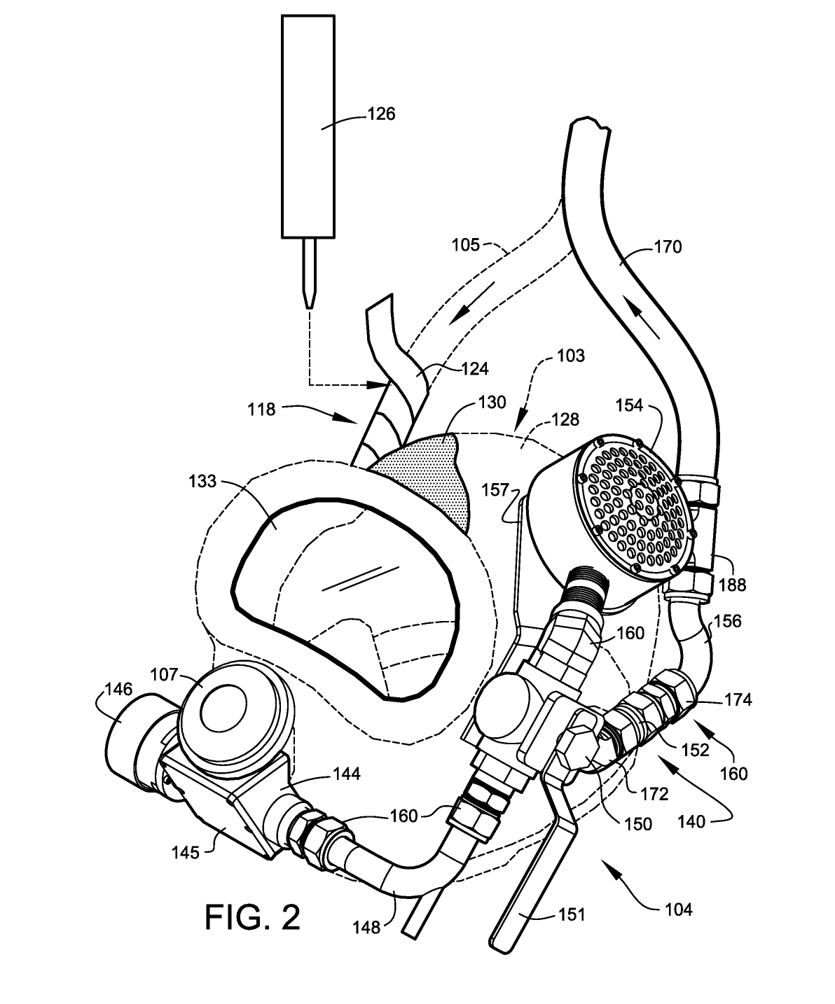

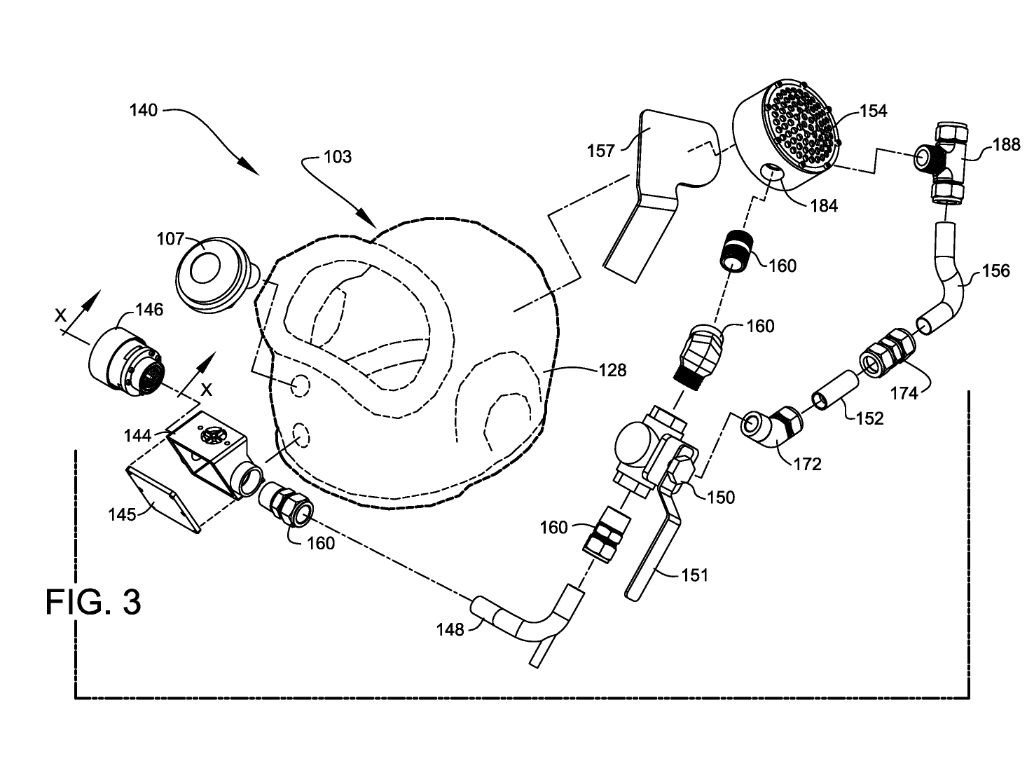

FIG. 2 shows a perspective view of an example dive helmet a RSE assembly. FIG. 3 shows an exploded perspective view illustrating components of an example dive helmet. An existing dive helmet 103 can include an existing commercial dive helmet or a military version similar to the existing commercial dive helmets. One example of an existing dive helmet includes the model SuperLite®-17B and the U.S. Navy version of the commercial Kirby Morgan SuperLite®-17B known as the MK-21. Another example includes the larger Kirby Morgan®-37 and the SuperLite®-27.

Testing of some of the aforementioned existing dive helmets 103 demonstrated that the existing dive helmets 103 fail to prevent intrusion of water when a diver's head moved from an upright position at any operational depth. This occurred despite the existing dive helmets 103 being equipped with an in-water exhaust subsystem 114, where the in-water exhaust subsystem 114 may have a double exhaust valve. Contamination of the breathing environment within the helmet 103 can result in reduced dive duration, and may result in immediate abort due to equipment failure (e.g., material deterioration). Furthermore, existing dive helmets 103 permitting intrusion of water can result in inhalation of contaminated microscopic water droplets from the in-water exhaust subsystem 114, thereby providing a direct passage of contaminants to the diver's lungs and bloodstream.

The RSE helmet assembly 104 can reduce or otherwise eliminate back contamination by aerosols, fumes, or particulates. The RSE helmet assembly 104 can permit continuous monitoring of the exhaust gas for indications of a breach in any part of the protective diving system 100, where the protective diving system 100 can provide a fully sealed and isolated breathing gas system.

A dive helmet 103 can include an outer shell 128, where the outer shell 128 can provide the central structure for mounting of components to make up a complete helmet. An example outer shell 128 can include lightweight glass-fiber reinforced thermal setting polyester (e.g., fiberglass) with carbon fiber reinforcements and a gel coat finish. Alternatively, another example outer shell 128 can include a non-corrosive metal composition, such as provided with a stainless steel Kirby Morgan®-77 helmet. Depending on the permeability of the outer shell 128, additional chemically-resistant coatings 130 may be applied to the outer shell 128. The additional chemically-resistant coatings 130 may be applied during retrofit procedures, where the coatings 130 may coat a permeable outer shell portion of an existing dive helmet 103. The coatings 130 may be configured to limit ingress of hazardous quantities of one or more hazardous materials 109 into the diver's breathing environment. In some implementations, the coatings 130 may reduce contact interaction between the hazardous material 109 and the permeable outer shell portion of the existing dive helmet 103.

In some implementations, the protective diving system 100 can include a side-block valve assembly 132, a bent tube 134, and a demand supply regulator 107 of the dive helmet 103. In some implementations, the side-block valve assembly 132, the bent tube 134, and the demand supply regulator 107 and their associated parts may include improved components 110 and sealant 126 made of suitable fluoroelastomers. In some instances, the side-block valve assembly 132, the bent tube 134, and the demand supply regulator 107 may be retained in an existing commercial dive helmet 103. In some implementations, modifications can be made to the aforementioned components using appropriate improved components 110 (e.g., FKM components). The FKM components may replace existing soft-goods components 106 identified as being incompatible with operation in hazardous diving environment 111. For example, the modification can include replacement of existing silicone regulator diaphragm of the demand supply regulator 107 and associated parts with an FKM equivalent selected among improved components 110. In some implementations, the standard side-block valve assembly 132, bent tube 134, and demand supply regulator 107 may be removed from outer shell 128 to allow for the replacement of standard silicone “pass-through” sealants with an appropriate fluoroelastomer sealant 126. In some implementations, the fluoroelastomer sealant 126 can include a room-temperature cured fluoroelastomer sealant 126.

The side-block valve assembly 132 may function to receive the main gas supply flow from the supply umbilical 105, support non-return valve, provide fittings/controls for an emergency gas supply, provide fittings/controls for ventilation and defogging (supplying a flow of air to the helmet's air train assembly), and provide a pathway for breathing gas to be routed to the demand supply regulator 107. The side-block valve assembly 132 may be chemically hardened to resist intrusion by one or more hazardous materials 109. The side-block valve assembly 132 further can further function to detect the start of the diver's inhalation and opening the supply regulator diaphragm, where opening the supply regulator diaphragm permits delivery of breathing gas to the oral-nasal mask within the helmet 103.

In conventional existing dive helmets 103, the supply regulator diaphragm of the demand supply regulator 107 closes as the diver exhales, causing the exhalation gas to flow through a regulator exhaust and a helmet exhaust into the in-water exhaust subsystem 114. The in-water exhaust subsystem 113 can be designed to route the exhaust from the demand supply regulator 107 to one or both exhaust valves that are part of “bubble-deflecting whiskers,” and out into the water. An example of such an arrangement can be found in Kirby Morgan Document 071031002 describing the Kirby Morgan Quad-Valve™ exhaust assembly, which can be accessible via the manufacturer's website. Empirical testing of an example in-water exhaust subsystem 114 showed that back contamination still occurred during operation. The RSE helmet assembly 104 can reduce or otherwise eliminate such back contamination. In some implementations, the RSE helmet assembly 104 can replace the in-water exhaust system 114.

The RSE helmet assembly 104 can provide a closed-circuit breathing system whereby the diver's exhausted gas is returned to the surface and exhausted to the atmosphere rather than exhausted into the water. In some implementations, modifications can be made to the existing dive helmet 103 by disabling the in-water exhaust subsystem 114, such as by removal. The modification can further include mounting or otherwise attaching the RSE helmet assembly 104 to provide a surface-return exhaust structure from a breathing environment of the dive helmet 103 to the surface. It is be noted that “surface” can include breathable atmospheres outside of the hazardous diving environment 111, such as the surface of the water, a diving bell, or a submerged habitat within the hazardous diving environment 111.

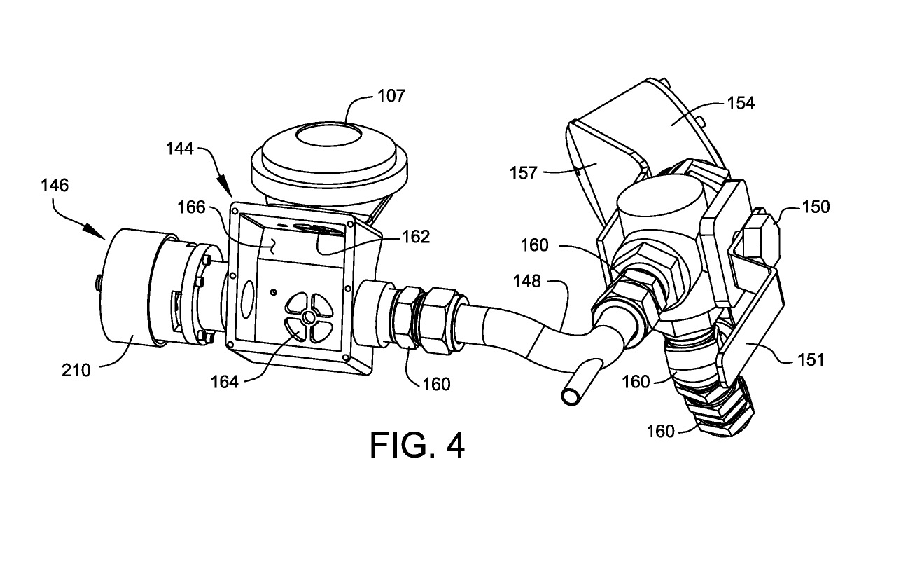

FIG. 4 shows a perspective view illustrating components of an RSE assembly. With reference to FIG. 1B, the RSE assembly 104 can include two component assemblies, which can include a helmet-mounted subassembly 140 and a surface-return subassembly 142. With reference to FIGS. 3 and 4, the helmet-mounted subassembly 140 can include an exhaust plenum 144, an exhaust plenum cover plate 145, an emergency dump valve 146, a first connector tube 148, a three-way bypass valve 150, a bypass flow fuse 152, a Demand Exhaust Regulator (DER) 154, and a second connector tube 156. In addition, the helmet-mounted subassembly 140 can include a support plate 157 to support DER 154 on the outer shell 128. The helmet-mounted subassembly 140 can further include a plurality of connector fittings 160 adapted to couple various components within the exhaust flow path. The exhaust plenum cover plate 145 has been omitted from the view in FIG. 4 to assist in the description of interior arrangements of exhaust plenum 144. In some implementations, the helmet-mounted subassembly 140 can have some or all of the connector tubing between the exhaust plenum 144 and a gas return hose 170 to have welded fittings. Such an arrangement may reduce the potential for leakage.

In some implementations, the exhaust plenum 144 may couple a regulator exhaust port 162 of the demand supply regulator 107 with a helmet main exhaust 164 within a plenum chamber 166. This can couple the demand supply regulator 107 and the plenum chamber 166 with the breathing environment of the dive helmet 103. In some implementations, the exhaust plenum 144 can be mounted or attached between the demand supply regulator 107 and a main exhaust body. The upper wall of the exhaust plenum 144 can mate with a regulator exhaust flange of the demand supply regulator 107. The rear wall of the exhaust plenum 144 can mate to the main exhaust body of the dive helmet 103. In some implementations, one or more fluoroelastomer sealing materials can be used to seal the exhaust plenum 144 to adjacent structures. In some implementations, the emergency dump valve 146 and the first connector tube 148 may be in fluid communication with the plenum chamber 166.

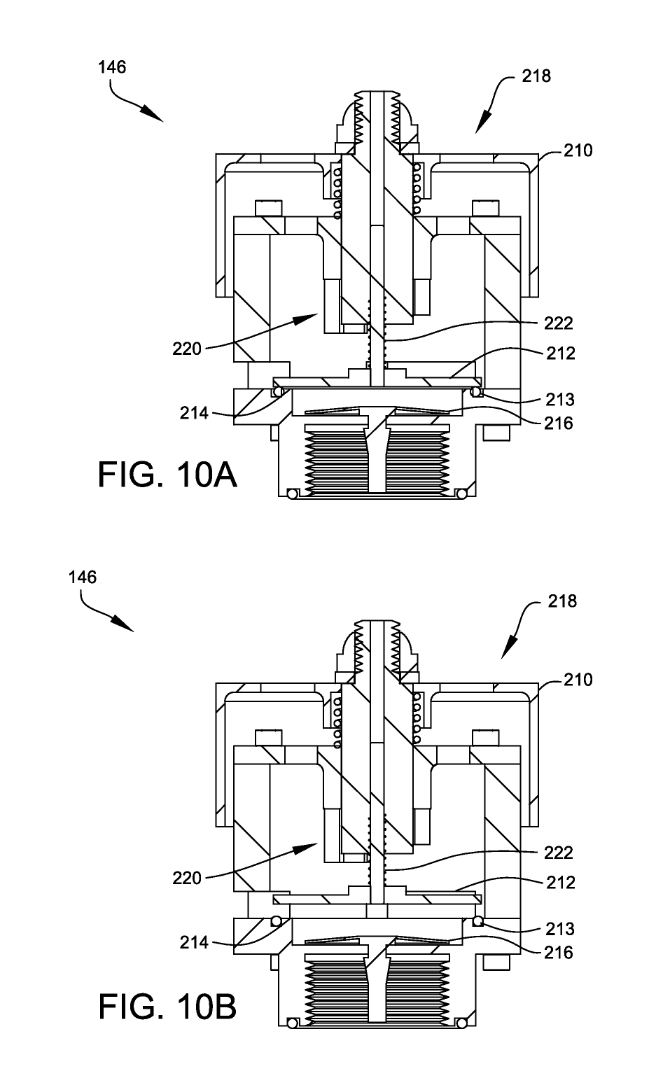

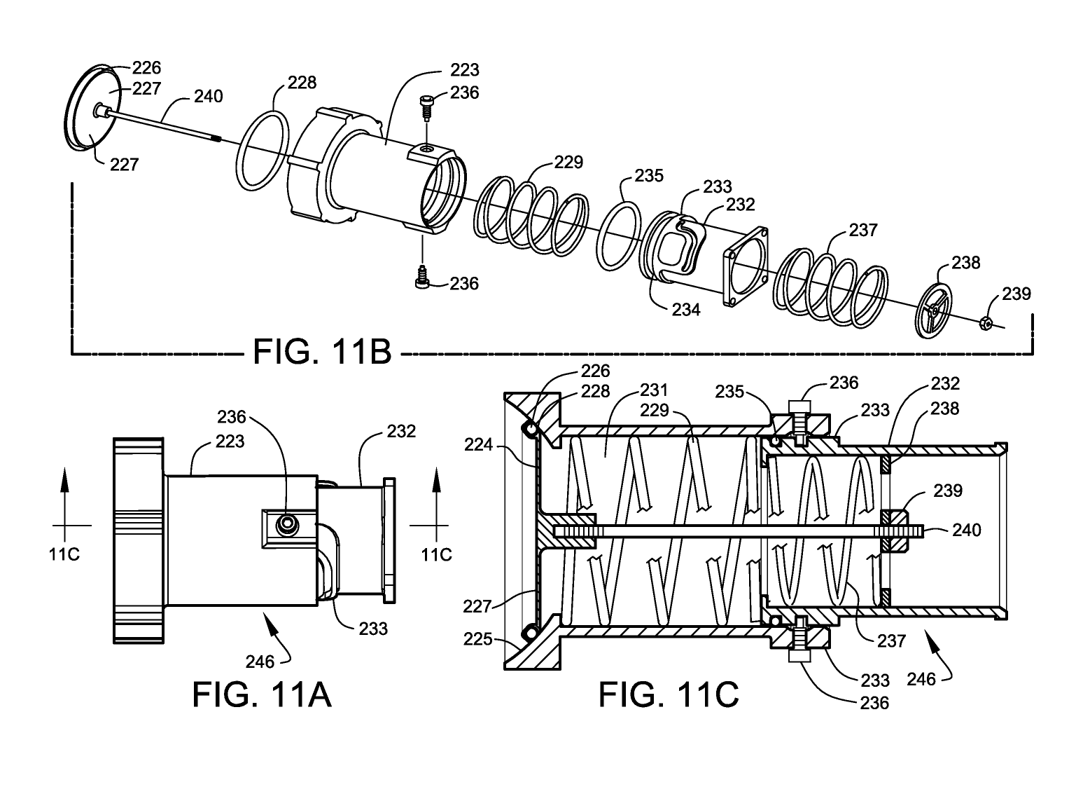

The emergency dump valve (EDV) 146 may serve to provide emergency relief pressure. Such emergency relief pressure may be useful or necessary when there is over-pressurization of the dive helmet 103 or emergency exhaust to ambient when there is catastrophic failure of the return system. An implementation of the EDV 146 is described with reference to FIGS. 10A-10B and 11A-11C.

In normal operation, exhaust gases can exit plenum chamber 166 through the first connector tube 148 and may be conducted to the three-way bypass valve 150. The three-way bypass valve 150 may serve as a gas-flow control valve to control the routing of the exhaust gas between the breathing environment of the dive helmet 103, DER 154, and the surface-return hose 170 of the surface-return subassembly 142.

A diver may set the three-way bypass valve 150 to one of at least three operational settings. In some implementations, one of the operational settings may be set by using a handle 151. One of the settings can be a normal operational setting to enable exhausting of the gas from the breathing environment of the dive helmet 103 through DER 154. Another one of the settings can be a free-flow setting to enable the exhausting of the gas from the breathing environment of the dive helmet 103 to flow directly to surface-return hose 170 without passage through the DER 154. In some implementations, this setting may be selected by the diver in the event of a failure of the DER 154. A third setting or emergency setting can disable the return-to-surface exhaust circuit by isolating the dive helmet 103 from both the DER 154 and the surface-return hose 170. In the event of a significant failure of the surface-return exhaust system, the diver may select this setting to prevent a dangerous loss of pressure within the dive helmet 103. In this setting, exhausting of the gas can occur substantially or entirely through the EDV 146.

With reference to the free-flow setting, a second connector tube 156 may serve as a means for conducting the exhaust gas diverted by the three-way bypass valve 150 directly to the surface-return hose 170. A bypass flow fuse 152 can be located “in-line” with the exhaust flow of the second connector tube 156. In some implementations, the bypass flow fuse 152 may be positioned between 45-degree compression adapter 172 and coupling 174. The bypass flow fuse 152 may be adapted to inhibit sudden rapid gas flow as a result of the development of any sudden pressure differential, across the fuse, which exceeds predefined or certain limits. The pressure differential can be a result of downstream component failure within the surface-return subassembly 142, such a as a line rupture within surface-return hose 170. Hence, the bypass flow fuse 152 can essentially serve as a check valve installed between the dive helmet 103 and the surface-return hose 170, whereby flow can be immediately or quickly inhibited upon sensing a pressure differential across the fuse that exceeds certain limits.

In some implementations, an exhaust pathway extending from the exhaust plenum 144 can have a minimum cross-sectional diameter to assist in maintaining acceptable levels of resistive breathing effort within the protective diving system 100. For example, the exhaust pathway can have a minimum cross-sectional diameter of about ¾″. This can be substantially equivalent to in-water exhaust arrangements.

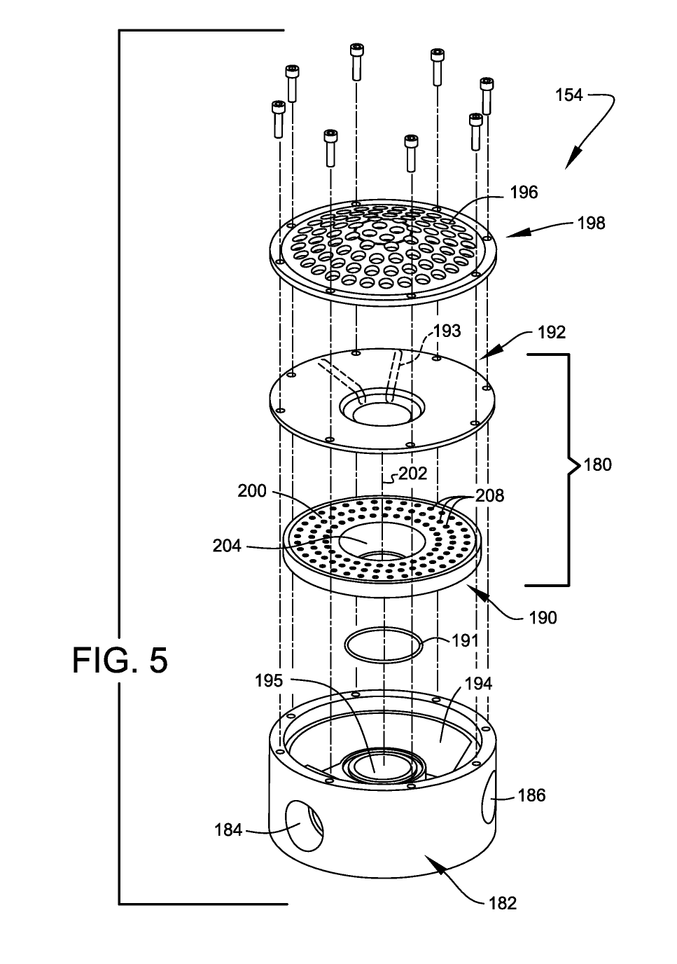

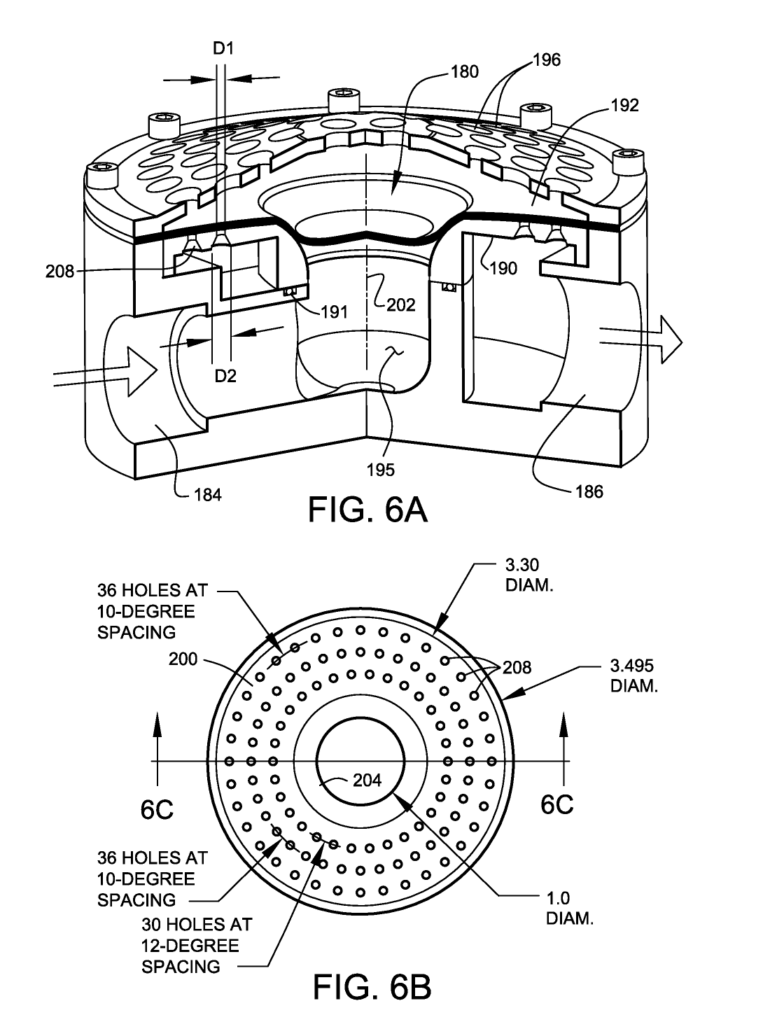

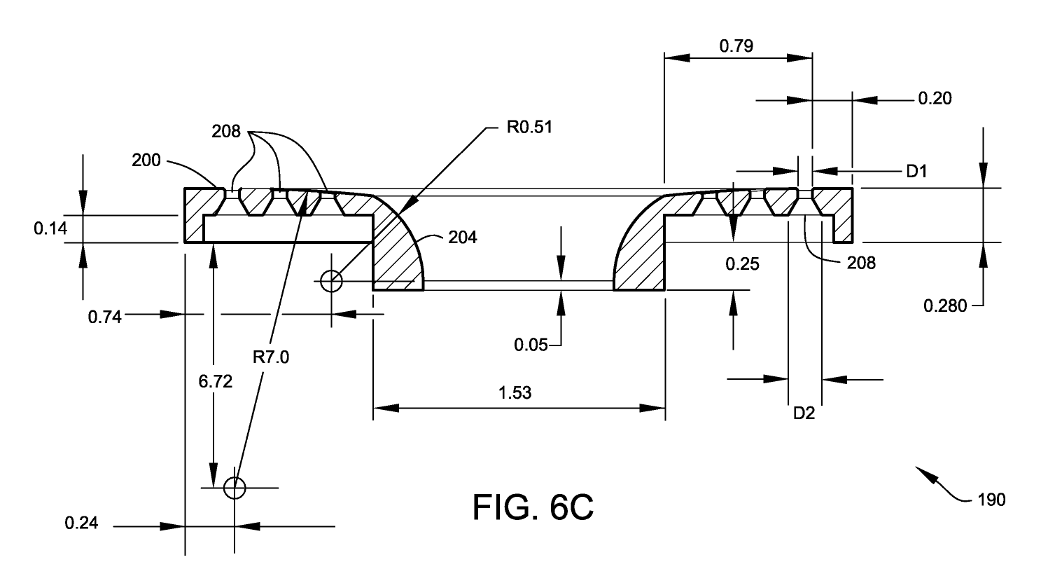

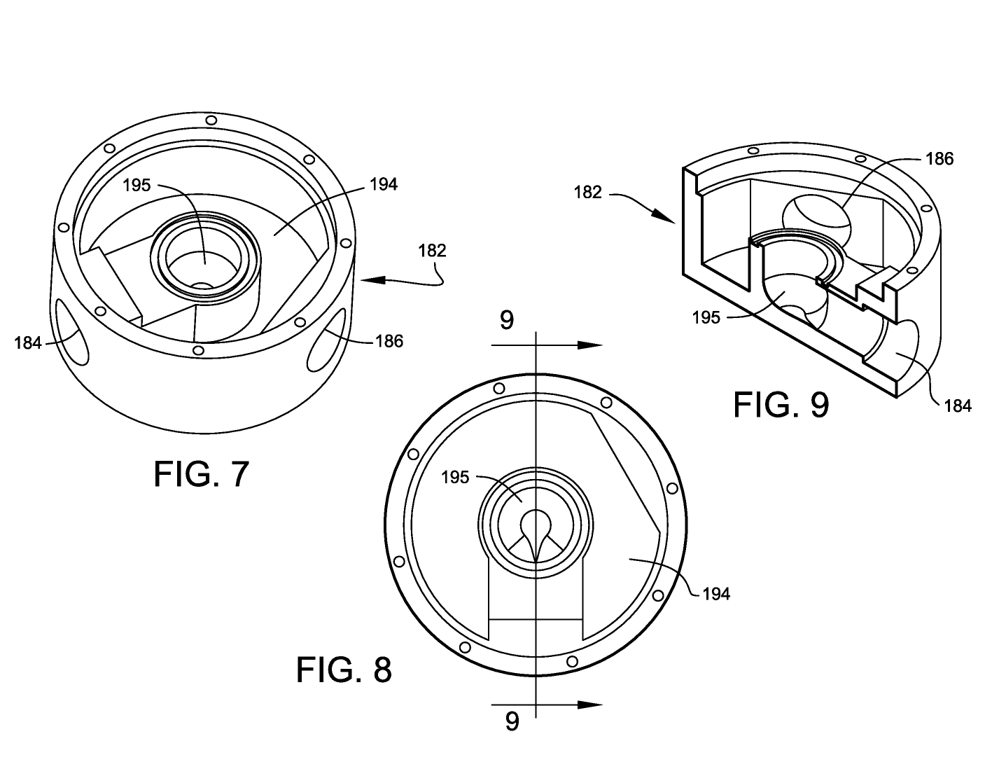

FIG. 5 shows an exploded perspective view of a demand exhaust regulator (DER) component. FIG. 6A shows a perspective cross-sectional view of a DER component. FIG. 6B shows a top view of a valve seat of the DER component of FIG. 6A. FIG. 6C shows a cross-sectional view through section 6C-6C of FIG. 6B illustrating arrangements of the valve seat of FIG. 6B. FIG. 7 shows a perspective view of a valve body of a DER component. FIG. 8 shows a top view of the valve body of FIG. 7. FIG. 9 shows a cross-sectional view of the valve body of FIG. 8 through section 9-9 of FIG. 8.

The DER 154 can function as a pressure-actuated valve that allows for controlled exhaust from the helmet-mounted subassembly 140 to the surface-return subassembly 142. The DER 154 can be a diaphragm-based system that can control the flow of the exhaust so that the suction acts on what is expelled from the diver. When a diver exhales, a pressure differential can be created so that the delta pressure of the exhaled air opens a valve in the DER 154 just long enough to get sucked out, and then the valve closes back up upon experiencing a negative pressure. In some implementations, the valve in the DER 154 can open upon activation by the diver. That way, the exhaust is free flowing towards the breathable environment for as long as there is a demand. The demand can be initiated by the diver exhaling or activating one or more components on the dive helmet 103 or the dry suit 611.

In some implementations, the DER 154 can include a cylindrical valve housing 182 adapted to house a demand-based valve assembly 180. The valve assembly 180 may be configured to control, essentially on demand, passage of breathing gas through the DER 154, thus maintaining a relatively static pressure equilibrium within the dive helmet 103. The valve assembly 180 can include a generally circular valve seat 190 and an exhaust diaphragm in a superimposed placement adjacent to the valve seat 190.

The valve housing 182 can include an inlet duct 184 to permit the introduction of breathing gas exhausted from the dive helmet 103. In some implementations, the breathing gas can travel via the exhaust plenum 144, first connector tube 148, and the three-way bypass valve 150. The inlet duct 184 of the valve housing 182 can be arranged to conduct the exhausted breathing gas from a side-positioned entry point on the valve housing 182, turning upward through a central bore 195 to the internally located valve assembly 180. The valve housing 182 can further include a corresponding outlet duct 186 to outlet the exhausted breathing gas, from the interior of the valve housing 182 after controlled passage through the valve assembly 180.

The valve seat 190 can be disposed between the inlet duct 184 and the outlet duct 186, where the valve seat 190 forms the upper portion of the central bore 195. In some implementations, the valve seat 190 can include a circumferential sealing surface 200 extending radially outward from a central axis of the central bore 195. The upper portion of the central bore 195 can include a smooth transition surface 204, thereby forming a smoothly sweeping transition between the central bore 195 and the circumferential sealing surface 200. In some implementations, all surfaces contacting the exhaust diaphragm may be smoothed to reduce contact wear on the exhaust diaphragm during operation.

In some implementations, the valve seat 190 can be removably mounted within the valve housing 182. The valve seat 190 can be sealed to the valve housing 182 using at least one fluoroelastomer O-ring 191, such as a Viton O-ring part number 1201T38 by McMaster-Carr of Chicago, Ill. In some implementations, the valve seat 190 and the overlying exhaust diaphragm may be captured within the valve housing 182 by a removable DER cover 198. In some implementations, the DER cover 198 can be mechanically fastened to the valve housing 182. In some implementations, the entire peripheral edge of the exhaust diaphragm 192 can be fully sealed to the valve housing 182 to isolate the exhaust pathway from ingress of contaminants originating from the diving environment 111. A plenum chamber 194 can be formed within the interior of the valve housing 182, which can be below the valve seat 190 and is in fluid communication with the outlet duct 186.

The sealing surface 200 may form a pressure seal with the exhaust diaphragm 192. The sealing surface 200 can include a plurality of gas-conducting passages 208, where each of the gas-conducting passages 208 enable the passage of gas from inlet duct 184 through valve seat 190 into the plenum chamber 194 and ultimately out of the outlet duct 186.

The exhaust diaphragm 192 can be arranged within the valve housing 182 to be in contemporaneous pressure communication with the inlet duct 184, the outlet duct 186, and ambient water pressure. The latter can occur by means of aperture openings 196 within the removable DER cover 198. In some implementations, the exhaust diaphragm 192 can be flexibly movable between a flow-blocking position and a flow-delivery position. In the flow-blocking position, the exhaust diaphragm 192 can substantially block the passage of the gas through the gas-conducting passages 208. This can occur by substantially engaging the sealing surface 200. In the flow-delivery position, the exhaust diaphragm 192 can enable the passage of the gas from the inlet duct 184 through the gas-conducting passages 208 to the plenum chamber 194 and out the outlet duct 186. This can occur by having the exhaust diaphragm 192 substantially disengage the sealing surface 200.

In some implementations, the valve assembly 180 can be configured to move the exhaust diaphragm 192 from a flow-blocking position to a flow-delivery position based on one or more conditions. One of the conditions can be the exhalation of gas from the diver, thereby causing the exhaust diaphragm 192 to move from a flow-blocking position to a flow-delivery position. As the diver exhales, a pressurizing bias force can be exerted on the exhaust diaphragm 192. Another one of the conditions can be activation for release of gas from the dive helmet system 600 or the dry suit system 601, such as activation for release of gas from a surface exhaust valve 616, discussed in more detail below.

As illustrated in the examples in FIG. 6A-6C, each of the gas-conducting passages 208 can include a frustoconical aperture. Each of the frustoconical apertures can include a small inlet diameter D1 and a larger outlet diameter D2. The small inlet diameter D1 can be configured to minimize unsupported areas of the exhaust diaphragm material when the exhaust diaphragm 192 is in the flow-blocking position. This allows for the use of relatively thin diaphragm thicknesses, which can be accompanied by a reduction in the required cracking force. The larger outlet diameter D2 can function to increase and optimize mass flow through the gas-conducting passages 208 and the valve seat 190. The sealing surface 200 can include a radial arrangement 102 of gas-conducting passages 208, where the average diameter D1 is about 0.07 inches and an average diameter D2 formed by a 60° chamfer cut into the underside of the valve seat 190 to a depth of about 0.09 inches. In some implementations, the upper edge of the diameter D1 can be eased by applying a 45° chamfer cut to a depth of about 0.01 inches. The valve seat 190 can be made of any suitable material, such as 316 stainless steel. All dimensions within FIGS. 6B and 6C are in inches unless otherwise noted.

The exhaust diaphragm 192 can be structured and arranged to generally conform to the surface geometry of the sealing surface 200 when engaged. The exhaust diaphragm 192 can be molded to substantially match the shape of the sealing surface 200 and the valve seat 190. In some implementations, the exhaust diaphragm 192 can be substantially radially symmetrical about a central axis 202, as shown in FIG. 5 and FIG. 6A. In some implementations, the exhaust diaphragm 192 can include a pair of ribs 193, located axially on the upper (non-sealing) surface of the exhaust diaphragm 192, to allow for eccentric bending, thus reducing the required cracking pressure. This can provide an asymmetrical stiffener to structurally stiffen at least one portion of the exhaust diaphragm 192, where such asymmetrical stiffness reduces the level of pressure forces required to flexibly move the portion of the flexibly movable exhaust diaphragm 192 from the flow-blocking position to the flow-delivery position. In some implementations, the exhaust diaphragm 192 can include a fluoroelastomer, such as at least one Viton product. The exhausted gases can exit the outlet duct 186 and subsequently routed through tee fitting 188 to surface return hose 170 of the surface-return subassembly 142.

The DER 154 can be mounted to a support plate 157 that can be supported from the outer shell 128. Those of ordinary skill in the art will readily understand that, under appropriate circumstances, such as issues of intended use, cost, etc., other demand valve arrangements may be implemented, such as variable pressure swing valves, variable pressure piston valves, swing arm valve assemblies, conventional demand valves, etc.

FIG. 10A shows a cross-sectional view through section X-X of FIG. 3 illustrating an emergency dump valve in normal operating configuration. FIG. 10B shows a cross-sectional view through section X-X of FIG. 3 illustrating the emergency dump valve in an emergency configuration. In the normal operating configuration, the EDV 146 can be adapted to exhaust about 10 inches of water above ambient. In the emergency configuration, the EDV 146 can be adapted to exhaust about 1 inch of water above ambient. The transition between normal operating configuration and the emergency operating configuration can be user selectable by the diver.

In some implementations, a diver can manually operate the EDV 146 by grasping the furthermost, outermost external portion 210 of a spring-loaded assembly 218 and pushing toward the dive helmet 103. The diver can simultaneously turn the portion 210 in a clockwise direction and then releasing. In some implementations, the diver can allow some or all of the helmet pressure to be relieved through the EDV 146. If the surface-return system malfunctions, this relief allows more time for the diver to reach safety or to correct the problem causing the off-nominal operation.

When the EDV 146 is set to emergency operating configuration, a valve-inhibiting member 212 can move away from an O-ring 213 of a valve seat 214, allowing a one-way exhaust valve 216 to operate freely, whereas it was previously biased to a closed position by the pressure engagement of the valve-inhibiting member 212. The valve-inhibiting member 212 can be held under pressure by the spring-loaded assembly 218 that can be engaged and disengaged by pushing and rotating a bayonet-style lock 220 to a closed and open position. By pushing and turning in a first direction, the valve-inhibiting member 212 is put into operation, and by pushing and turning in a second direction, the valve-inhibiting member 212 becomes inoperative.

The valve-inhibiting member 212 can function as a pressure relief valve. In some implementations, the EDV 146 can be automatically opened by an increase in pressure within the dive helmet 103 above the cracking pressure of the valve-inhibiting member 212. This pressure may overcome the spring pressure of a secondary spring 222 of the valve-inhibiting member 212, thereby allowing the valve-inhibiting member 212 to be moved away from its closed position long enough for pressure in the dive helmet 103 to vent to the ambient pressure of the water. In some implementations, the valve-inhibiting member 212 can return to its closed position when the internal pressure of the dive helmet 103 can no longer overcome the pressure of the secondary spring 222. The automatic venting process of the EDV 146 can repeat until interrupted by another process.

FIG. 11A shows a side view of an example emergency dump valve. FIG. 11B shows an exploded perspective view illustrating components of the emergency dump valve of FIG. 11A. FIG. 11C shows a cross-sectional view through section 11C-11C of FIG. 11A of the emergency dump valve of FIG. 11A. The EDV 246 can have an internal spring and guide mechanism, with an adjustable spring force on the poppet. The EDV 246 can include a valve body 223, forming a valve knob, and a poppet 224, which sits within a polished spherical valve chamber 225 of the valve body 223. The poppet 224 can include an O-ring gland 226, which can be obtusely angled with respect to a poppet seat 227. This defines a circular seal geometry for receiving O-ring 228, forming a slidable seal between the poppet seat 227 and the spherical valve chamber 225. A knob spring 229 can sit within a chamber 231 of the valve body 223 and can support a base 232. The base 232 can include an O-ring gland 234 for receiving a second O-ring 235 for slidably sealing the inner chamber of the valve body 223. The base 232 can further include an outer guide 233 which can be engaged via guide pins 236 for adjustably retaining the base 232 within the valve body 223. This allows for a switch between high and low pressure configurations for the EDV 246. A valve spring 237 can sit within the base 232 and can be retained via a valve spring retainer 238 and an adjustment nut 239, which engage a threaded poppet shaft 240. Such an assembly can result in a valve that does not leak right up to the set pressure.

A cracking pressure of the EDV 246 can be set during assembly. The difference between the cracking pressure in the emergency mode and the cracking pressure in a nominal mode can be controlled by the valve geometry. In the nominal mode, the DER 154 should crack (e.g., open) without the EDV 246 cracking. Hence, the EDV 246 can limit the helmet pressure to prevent injury to the diver. For diver safety, the EDV 246 can include a design requirement to crack at a pressure lower than about 1.08 psi, or as close to set pressure as possible.

With reference to FIG. 1A and FIGS. 12-14E, a dry suit system 601 can incorporate HMRSEDS 300 as described above. The dry suit system 601 can be configured to integrate with a surface supplied subsystem 112 incorporating supply control station 116, and surface-return subassembly 142 of the helmet system 600. The protective diving system 100 can include a dive helmet system 600 and a dry suit system 601, where the dry suit system includes a dry suit 611 and a surface exhaust valve 616 coupled to the dry suit. The surface exhaust valve 616 can be configured to receive gas from the dry suit and exhaust gas to a RSE assembly 104. The dry suit system can include one or more components including fluoroelastomers.

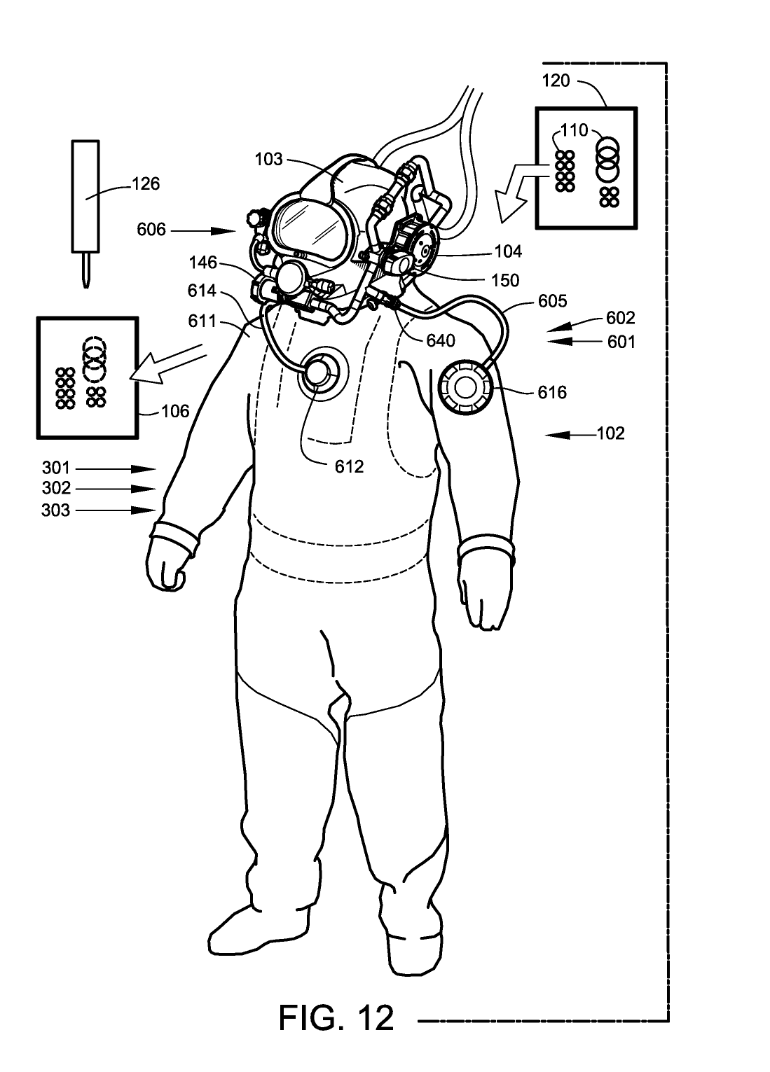

FIG. 12 shows a perspective view illustrating an example dive helmet and dive suit including a hazardous-environmental modification assembly. FIG. 12 shows an example of a dry suit 611 modified with to isolate the diver from the hazardous diving environment 111. In some implementations, the dry suit 611 can be modified using the HEMA 120. In some implementations, the dry suit can include an existing commercial dry suit or similar military version. An example of an existing dry suit can include the Viking HD 1500 Dry Suit, where the existing dry suit includes a rubber shell and an inner lining. The existing dry suit 611 can include an inlet valve 612 and an exhaust valve 613, which is shown in FIG. 1C. The inlet valve 612 can inflate the dry suit 611 through an inflation hose 614. The exhaust valve 613 can control the air volume inside the suit as needed for pressure and flotation control. The exhaust valve 613 may also be referred to as a “dump valve,” which can release air into the surrounding water. As with the in-water exhaust subsystem 114 of existing dive helmets 103, the in-water exhaust valve 613 of existing dry suits 611 may expose the suit environment to back contamination.

One or more components of the dry suit system 601 can provide a continuous barrier to substantially isolate the diver from the diving environment 111. In some implementations, the existing soft-goods components 106 of the dry suit 611 may be identified and replaced by improved components 110. The improved components 110 may be part of the HEMA 120, where the improved components 110 can include a fluoroelastomer. The improved components 110 may be selected to match or improve the size, required quantity, and mechanical properties of the existing soft-goods components 106 of the dry suit 611. In addition, the dry suit system 601 can include one or more components having a chemically resistant sealant 126. In some implementations, a chemically resistant hose covering 118 may be used where appropriate. Thus, the dry suit system 601 can include materials, including fluoroelastomers, which are substantially resistant to chemical attack and substantially resistant to permeation by one or more hazardous materials 109.

In some implementations, the dry suit system 601 can include a chemically hardened dry suit having one or more components made of a fluoroelastomer composition to substantially isolate the diver from the diving environment 111. In some implementations, the dry suit system 601 can include an existing dry suit 611 modified using the HEMA 120, where the modifications can incorporate a fluoroelastomer composition into the dry suit 611. The modifications can reduce physical degradation of the dry suit and its associated components upon contact with one or more hazardous materials 109 as well as reduce transmission of hazardous quantities of the one or more hazardous materials 109 into the dry suit 611 by permeation. The chemically hardened dry suit or the modified dry suit can be configured to receive gas from the main gas supply flow from supply umbilical 105.

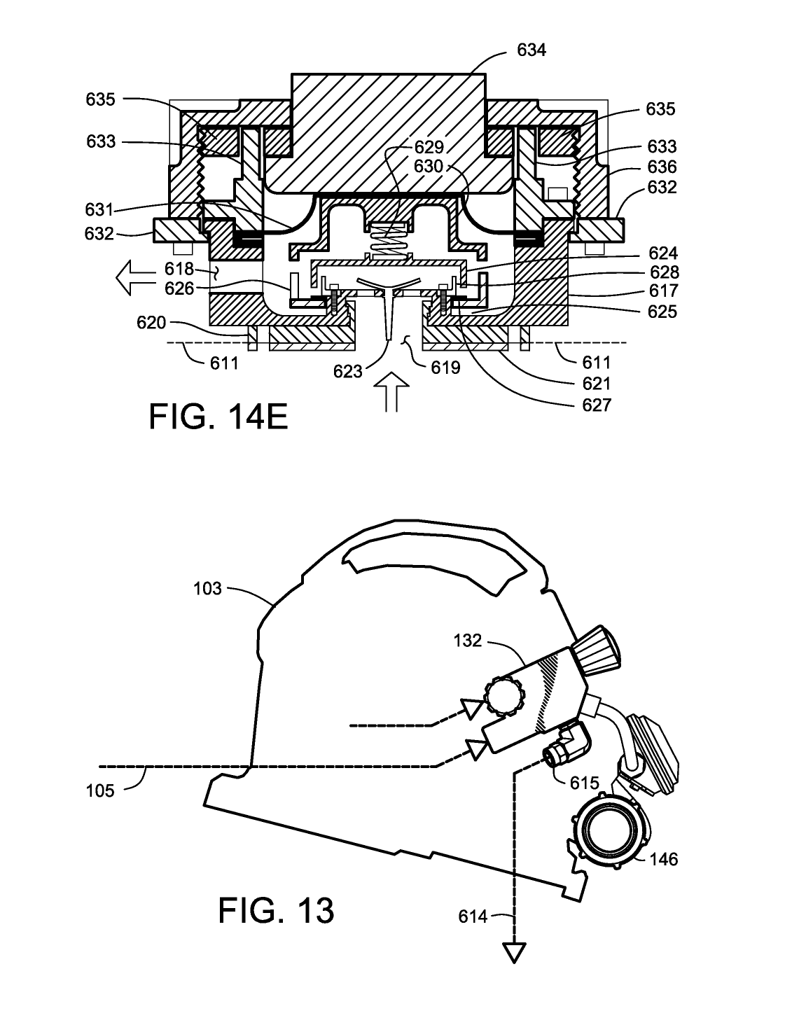

FIG. 13 shows a side view of a dive helmet including a side block valve assembly including a connector for coupling the side block valve assembly to an inflation hose of a dry suit system. As illustrated in FIG. 13, an inlet system 606 of the dry suit 611 can couple with the helmet air supply system. The valve 612 can be configured to receive air supply through the side block valve assembly 132 of the dive helmet 103. In some implementations, an inflation hose 614 can couple to the side block valve assembly 132 of the dive helmet 103 via a connector 615. One or more of the side block valve assembly 132, the inflation hose 614, and the connector 615 can be made of appropriate chemically resistant materials. In some implementations, sealants for the aforementioned components can be made of appropriate chemically resistant materials.

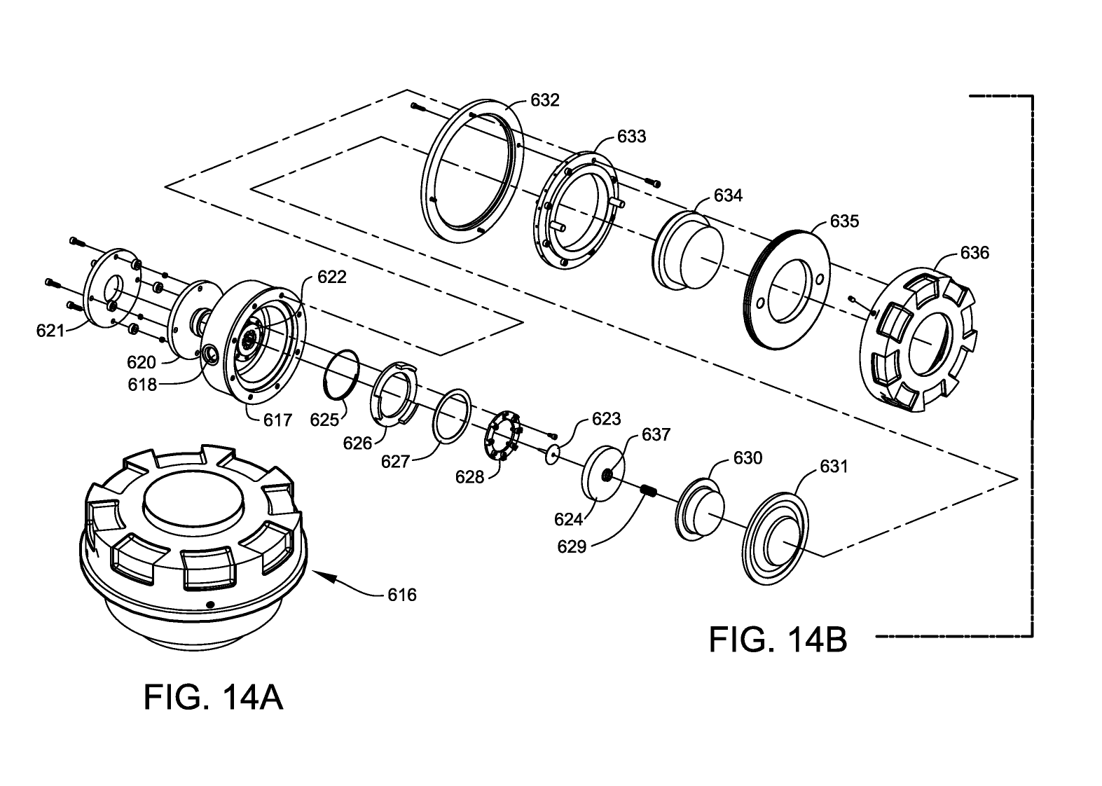

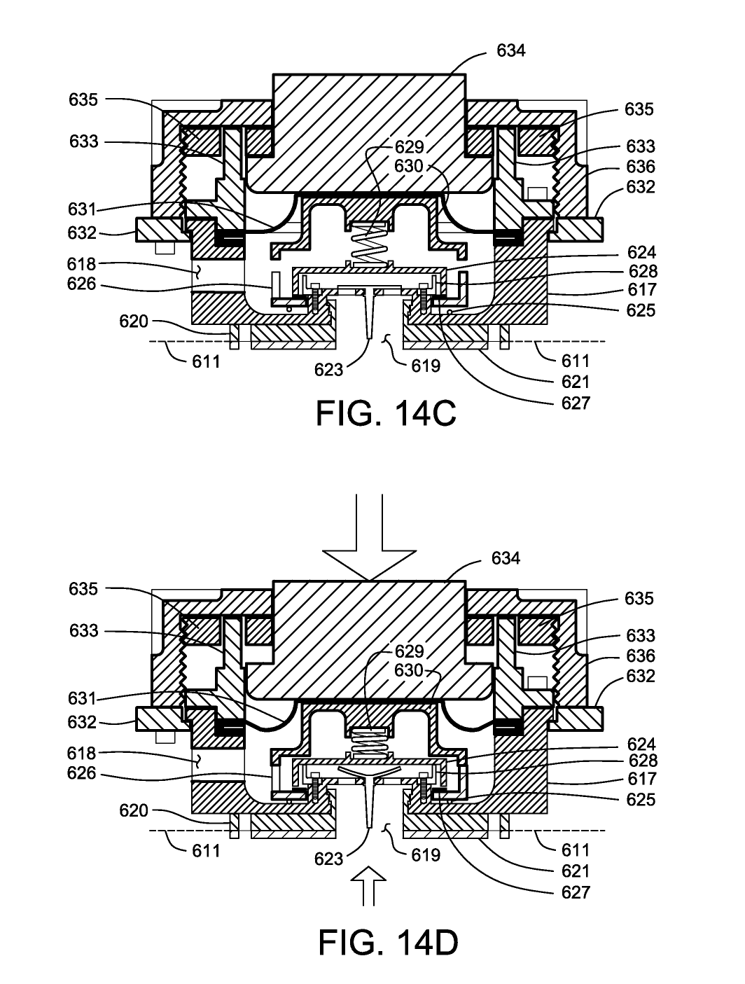

FIG. 14A shows a perspective view of an example surface exhaust valve for a dry suit system. FIG. 14B shows an exploded perspective view of components of the surface exhaust valve of FIG. 14A. FIG. 14C shows a cross-sectional view of the surface exhaust valve of FIG. 14A. FIG. 14D shows a cross-sectional view of the surface exhaust valve of FIG. 14A upon opening the valve by pressing a purge button. FIG. 14E shows a cross-sectional view of the surface exhaust valve of FIG. 14A upon opening the valve by a pressure differential. A surface exhaust valve 616 may be coupled to a dry suit 611 in a dry suit system 601. The surface exhaust valve 616 may replace in-water exhaust valve 613 of existing dry suits 611. The surface exhaust valve 616 may be configured to properly adjust the buoyancy of the diver and return the exhaust gas to a breathable atmosphere outside of the diving environment 111, such as a surface above water. Such an arrangement can eliminate any pathway for back contamination by aerosols, fumes, particulates, etc. As with the helmet system 600, this improvement can allow for continuous monitoring of the exhaust gas for indications of a breach in any part of a sealed and isolated breathing gas system.

With reference to FIGS. 1A, 1C, and 12, a return-surface exhaust (RSE) dry suit assembly system 602 can include the surface exhaust valve 616 coupled or configured to be coupled to a dry suit 611. The surface exhaust valve 616 may be configured to receive gas from the dry suit 611 and exhaust the gas to an RSE assembly, as described above. In some implementations, the surface exhaust valve 616 can exhaust gas to the RSE assembly through an exhaust or return umbilical 605, thereby preventing back contamination. In some implementations, the return umbilical 605 may be coupled to an RSE assembly 104 that may be part of the helmet system 600. In some implementations, the return umbilical 605 may be coupled to an RSE assembly 104 that is independent of the helmet system 600.

In some implementations, the surface exhaust valve 616 can include an inlet port 619 for receiving gas from the dry suit 611, and an exhaust port 618 for exhausting gas through the return umbilical 605. In some implementations, the surface exhaust valve 616 can have an adjustment feature for manually adjusting the cracking pressure. A poppet 624 of the surface exhaust valve 616 can be configured to operate in either a manual or automatic mode, and provide an acceptable cracking pressure and a sufficient maximum cracking pressure.

In the manual mode, a diver can manually release air from the dry suit 611. For example, the diver can release air by depressing a purge button 634. In the automatic mode, the surface exhaust valve 616 can be configured to automatically release air. For example, during an ascent, when the diver lifts his/her left arm (placing the surface exhaust valve 616 at the highest point of the dry suit 611), air may be released. In the automatic mode, the surface exhaust valve 616 can be set to the lowest operating pressure to keep as little air in the dry suit 611 as possible or as desired. This can be done by rotating a knob 636 of the upper valve body and that is internally-threaded. The knob 636 can be threadably engaged with a movable inner ring 635, which can be engaged with the purge button 634. The rotation of the knob 636 can adjust the position of the purge button 634 and the diaphragm base 630, relative to the poppet 624, as the inner ring 635 translates up and down along the internal threads of the knob 636. A knob base ring 632 of the knob 636 can be configured to engage the valve base 617 to form a stop and to prevent the disassembly of the knob 636 during adjustment.

A spring 629 can be located between the diaphragm base 630 and the poppet 624, where the spring 629 can function to bias the poppet 624 towards a sealed position adjacent to the gasket 627 and the gasket seat 626. A sufficient pressure differential across the valve base 617 can overcome the force applied by the spring 629, resulting in automatic cracking of the poppet 624 and an umbrella valve 623, thus permitting movement of air across the valve base 617 from the inlet port 619 to the exhaust port 618. Manually pressing the purge button 634 can result in the automatic cracking of the poppet 624 and the umbrella valve 623 by moving the gasket seat 626 downwardly away from the poppet 624 using the diaphragm base 630 as an intermediate actuator. A seat spring 625, located below the gasket seat 626, can function to bias the gasket seat 626 upwardly toward the poppet 624.

The surface exhaust valve 616 can be structured to have a flow capacity sufficient to accommodate an emergency ascent, such as 60 feet/minute, while the diver maintains reasonable buoyancy force offsetting, such as about 20 pounds. The internal components of the surface exhaust valve 616, can include the valve base 617 coupled to a suit connector 620 and a backing plate 621, which are designed to properly mate and seal to a dump valve port of the dry suit 611. The valve base 617 can include an exhaust port 618, an inlet port 619, and an aperture valve seat 622 for retaining the umbrella valve 623 and the poppet 624 via gasket seat spring 625, gasket seat 626, gasket 627, and retainer gasket 628. The poppet 624 can include a spring seat 637 for receiving the spring 629, which can couple to the diaphragm base 630, having a spring retainer 639 for retaining the spring 629 and supporting a diaphragm 631. The purge button 634 can be supported on the diaphragm 631. The knob base ring 636 can mechanically fasten to the valve base 617 and retain the assembly.

In some implementations, the RSE dry suit assembly system 602 can be configured to integrated with the RSE assembly 104, as shown for example in FIGS. 1A and 12. In some implementations, the surface exhaust valve 616 of the RSE dry suit assembly system 602 can be coupled to the RSE assembly 104 via the return umbilical 605. In some implementations, the return umbilical 605 can couple to the helmet exhaust via a connector 640. In some implementations, the return umbilical 605 can couple between the EDV 146 and the three-way bypass valve 150 via the connector 640.

In some implementations, the RSE dry suit assembly system 602 can include at least the surface exhaust valve 616 coupled to the dry suit 611, the return umbilical 605 coupled to the surface exhaust valve 616, and the RSE assembly 104. At least one of the surface exhaust valve 616, the return umbilical 605, and the RSE assembly 104 can include a fluoroelastomer. In some implementations, at least one of the surface exhaust valve 616, the return umbilical 605, and the RSE assembly 104 can include one or more sealants, where the one or more sealants can include a fluoroelastomer.

In some implementations, the existing dry suit 611 can be retrofitted and modified to include appropriate chemically resistant components and chemically resistant sealants. The dry suit 611 can be retrofitted using the HEMA 120 as describe above.

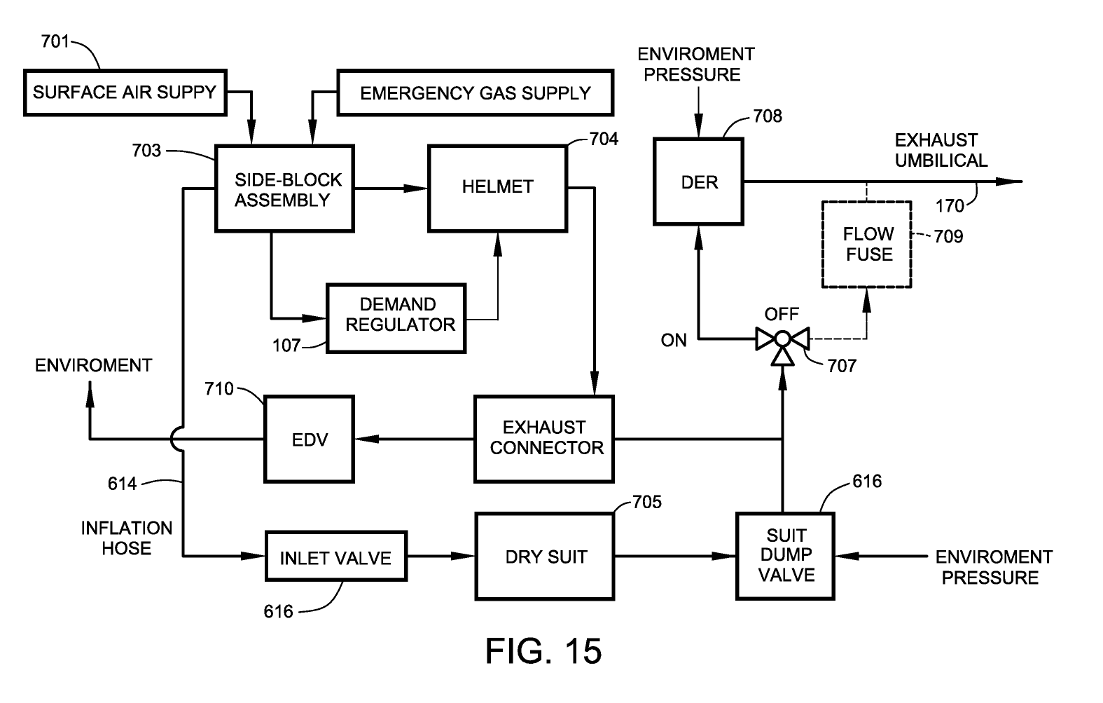

FIG. 15 shows a schematic diagram illustrating air flow through a surface supplied and regulated surface exhaust system. The schematic diagram can show the air flow for the combined surface-supplied and regulated surface exhaust system including the combined surface-supplied assembly of the dry suit 705 and the dive helmet 704. A surface air supply 701 can include at least two sources. Air can enter the dive helmet 704 through a helmet inlet assembly 703 (similar to side block valve assembly 132), which provides breathing and inflation gas for the dive helmet 704 and the dry suit 705. The exhausted air both the dive helmet 704 and the dry suit 705 routes between an EDV 710 and a three-way valve 707 (similar to EDV 146 and valve 150 of FIGS. 2-4). The three-way valve 707 allows for the diver to divert exhaust gas through either a DER 708 in the “On” position, through a bypass 709 containing a flow fuse, or through the EDV 710 in the “Off” position. The exhaust path during nominal operations can be shown as the “On” position, with flow diverted through the DER 708. In the event the DER path is not functioning, the diver could switch to the bypass mode designed to maintain isolation of the diver from the environment while aborting a dive operation. As a last resort, if both the nominal and the bypass exhaust paths are not functioning, the diver could switch to the “Off” position such that the exhaust gas would release to the environment through the EDV 710 while aborting a dive operation. In some implementations, the bypass mode can be eliminated, such as by plugging the bypass opening and removing the excess plumbing. This set up can be suitable for a case in which an appropriate flow fuse is not available. In this case, the three-way valve 707 can function as a two-way valve to select between the EDV 710 and the DER 708.

A flow fuse 709 can be capable of maintaining helmet pressure near or at the ambient hydrostatic pressure. In some implementations, the helmet pressure can be maintained all of the following conditions: (1) as a nominal path that includes sufficient supply air and all exhaust routed through an exhaust surface panel; (2) loss of supply air; and (3) in a condition in which the exhaust pressure is no longer controlled by the exhaust surface panel, such as due to a malfunctioning back pressure regulator or if the return umbilical or the pneumofathometer hose were to become detached or cut. The bypass can maximize flow capacity, allowing as much free flow as feasible. In some implementations, the bypass should not be the limiting component in the system flow capacity.

If the flow fuse component is to be used in the bypass exhaust path, then the minimum flow requirement (at the inlet of the fuse) can be much higher than the initial flow rate specified. However, the flow rate through the flow fuse can be limited to the amount of air that can be supplied. If the bypass allowed more flow than what the supply regulator can provide, a dangerous “squeeze” can result that can cause injury or death. Any disruption in the flow of supply air to the supply regulator can result in this dangerous squeeze. Therefore, under such circumstances, it may be desirable to eliminate the bypass path.

Those with ordinary skill will readily appreciate that, under appropriate circumstances, considering such issues as cost, future technologies, etc., other system arrangements, such as separate supply umbilicals for the helmet and/or dry suit system, inflation hose and umbilical combined at any practical point in the return and supply lines of the helmet and/or dry suit system, etc., may suffice.

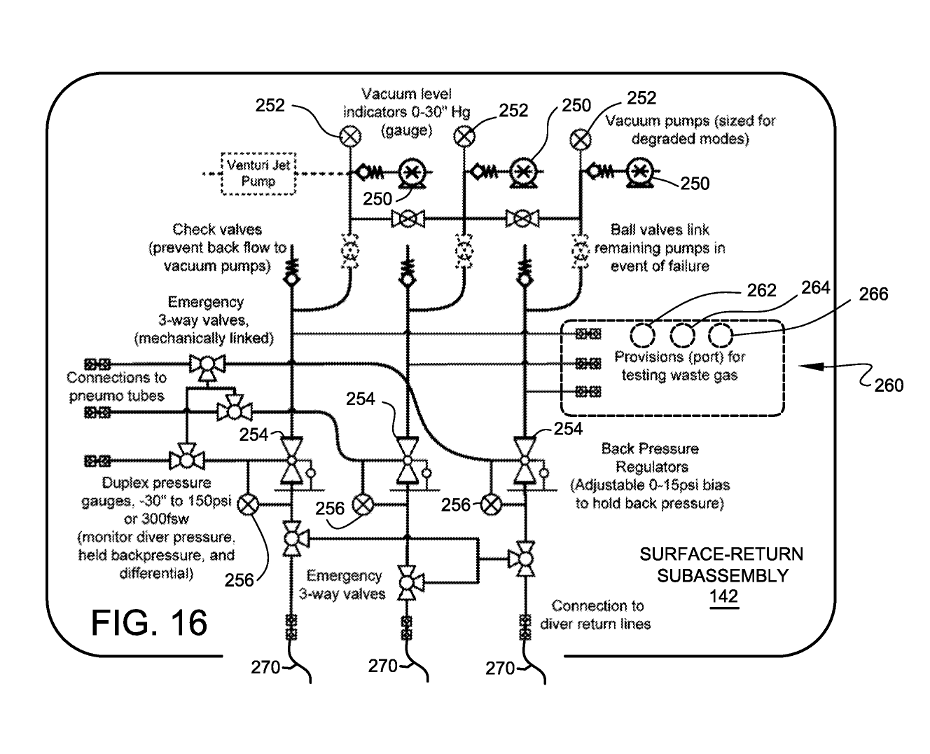

FIG. 16 shows a schematic diagram illustrating an example surface-return assembly. A surface-return assembly 142 can include a surface-return hose 170 and a surface control unit 230, as shown in FIGS. 1A-1C and 12. In some implementations, the surface-return hose 170 can conduct exhaust gases from the helmet-mounted subassembly 140 to the surface control unit 230.

The surface control unit 230 can be configured to provide an indication of the diver pressure and backpressure regulator pressure, provisions for testing/sampling return gas for hazardous materials 109, a vacuum source 250 for shallow mode operations, and a backpressure regulator 254 to hold backpressure on the DER 154. In some implementations, the surface control unit 230 can include a reduced-pressure source, such as a vacuum pump 250 or at least two vacuum pumps 250. Each vacuum pump 250 can be used to maintain vacuum on the DER 154 at all times during dive operations. Crossovers between the pumps 250 can be provided to allow for a single fault tolerance in the event of a single pump failure. Each of the vacuum pumps 250 can include a vacuum monitoring gauge 252 adapted to monitor generated vacuum levels. In some implementations, the vacuum pump 250 is capable of handling at least 62.5 liters per minute with 7.5 pounds per square inch vacuum. The vacuum pump 250 can be an oil-less rotary vane design.

The reduced pressure produced by the vacuum pumps 250 can be communicated to the surface-return hose 170 through a system of pressure controls and monitors. This can provide a reduced-pressure communicator establishing fluid communication between vacuum pumps 250 and a surface-return hose 170. In some implementations, a backpressure regulator 254 can be configured to regulate levels of reduced atmospheric pressure communicated between the vacuum pumps 250 and the surface-return hose 170.

In some implementations, the surface control unit 230 can include at least one pressure indicator, such as a duplex pressure gauge 256 configured to indicate a pneumatic reference pressure, and at least one indication of the operating pressure at the DER 154. More specifically, the duplex pressure gauge 256 can display a pneumofathometer reference pressure and a pressure at the backpressure regulator 254. The difference between the two measurements can indicate the bias held by the backpressure regulator 254. For example, the duplex pressure gauge 256 can be capable of displaying −30 in. Hg to 150 psi. In some implementations, a gauge suitable for use as the duplex pressure gauge includes the Weksler model BB14P by Weksler Glass Thermometer Corp. of Charlottesville, Va.

In some implementations, the surface control unit 230 further includes a breathing-gas monitoring unit 260, where the breathing-gas monitoring unit 260 is configured to monitor the exhausted breathing gas of the breathing environment for levels of hazardous material 109. The breathing-gas monitoring unit 260 can include at breathing-gas sampling component 262 configured to sample the breathing gas of the breathing environment. In some implementations, the gas samples can be taken at sampling ports located between the backpressure regulator 254 and vacuum pumps 250. The breathing-gas monitoring unit 260 can further include a measurement component 264 configured to measure the levels of at least one hazardous material 109 in the sample to determine if the levels of the hazardous material 109 falls within a predefined or certain range. In addition, the breathing-gas monitoring unit 260 can include at least one hazardous-condition indicator 266 to indicate if the levels of the hazardous material 109 within the breathing environment exceed a predefined or certain range. If such a condition were to occur, the hazardous-condition indicator 266 would provide an indication to the surface tender/operator to allow for steps to be taken. Those of ordinary skill in the art will appreciate that, under appropriate circumstances, considering such issues as intended use, hazardous environment, etc., other monitoring arrangements, such as in-helmet chemical detectors, water sampling devices, etc., may be used.

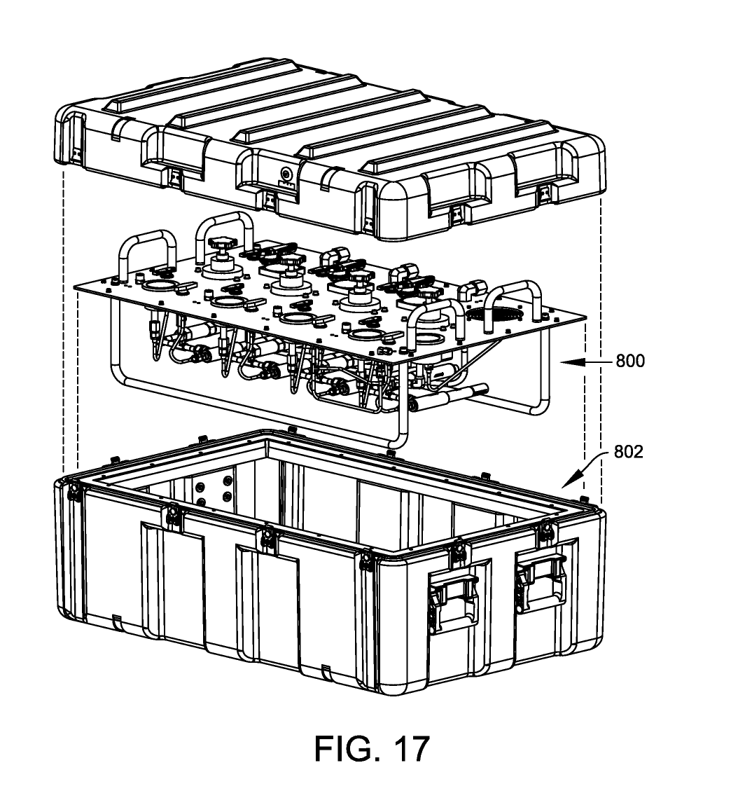

FIG. 17 shows a perspective view of an example tender station for a dive system. As shown in FIG. 17, a supply control and surface-return assembly 800 can be contained in a portable tender unit 802. An existing portable tender may be outfitted with the necessary assembly and return umbilical to be integrated with the existing surface unit and umbilical.

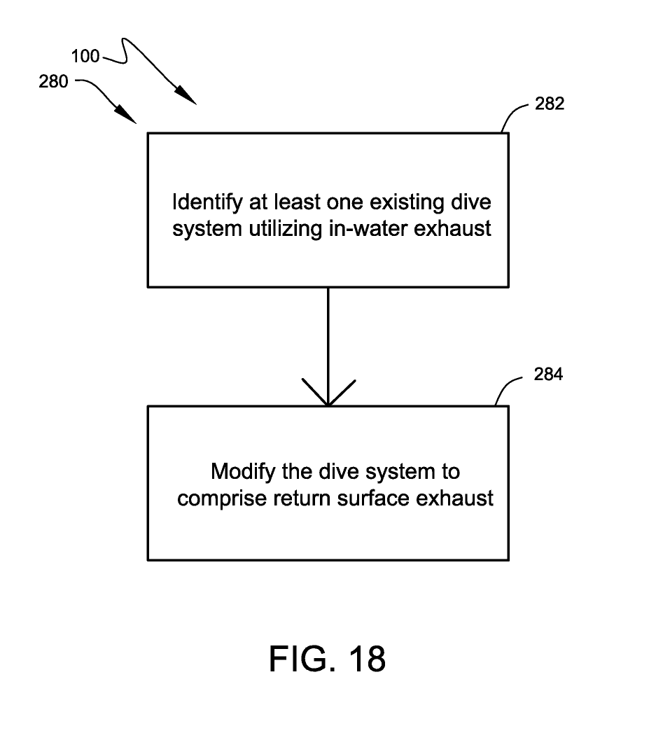

FIG. 18 shows a flow diagram illustrating an example method of using a retrofitted underwater dive system. The method 280 can be used to avoid health hazards related to diving operations. In accordance with the protective diving system 100, the method 280 can be related to the use of a retrofitted underwater dive system 101 to protect a diver operating in a hazardous diving environment according to some implementations. In an initial step 282, an existing underwater dive system 101 can be identified for use in the diving operation. By way of an example, the diving operation can include the carrying out of maintenance work within a municipal reservoir where biological contaminants can be conveyed into the diver's breathing environment from within the diver's environment. As indicated in a step 284, an existing underwater dive system 101 can be modified by removing in-water exhaust subsystem 114 and adding a RSE assembly 104 to enable the return of breathing gas from the breathing environment of the dive helmet 103 to the surface. Thus, use of such a retrofitted commercial dive system in such waters can assist in avoiding water contamination relating to the exhaust of breathing gas.

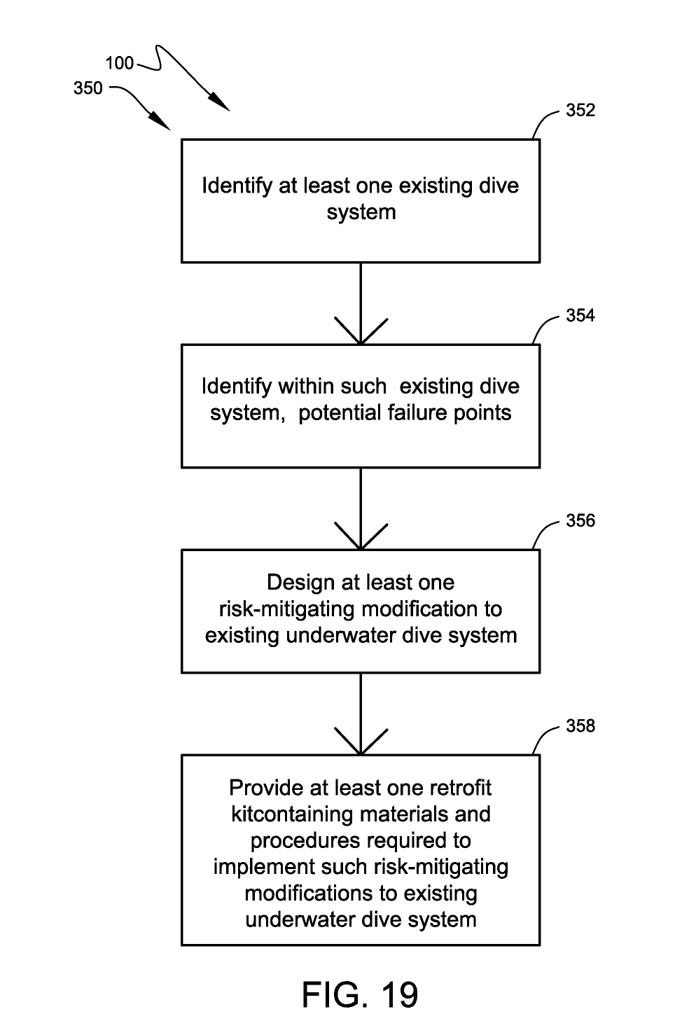

FIG. 19 shows a flow diagram illustrating an example method of retrofitting an existing underwater dive system. In an initial step 352 of a method 350, an existing underwater dive system 101 is identified. Next, in step 354, potential hazardous-material-caused failure points, which may result in injurious introduction of a hazardous material 109 into the diver's breathing environment, are identified with respect to the existing underwater dive system 101. This can include analysis and identification of materials vulnerable to direct chemical degradation and chemical infiltration. In step 356, one or more modifications to reduce risk to the diver are implemented with respect to the existing underwater dive system 101. This can reduce mitigate the risks associated with the hazardous-material-caused failure points identified in step 354. In step 358, a retrofit kit can be provided, where the retrofit kit can include materials and procedures for implementing the modifications to the existing underwater dive system 101 to produce HMRSEDS 300. In some implementations, the retrofit kit can include the HEMA 120. In step 358, at least one of the modifications includes replacing at least one chemically-sensitive component with at least one fluoroelastomer replacement.

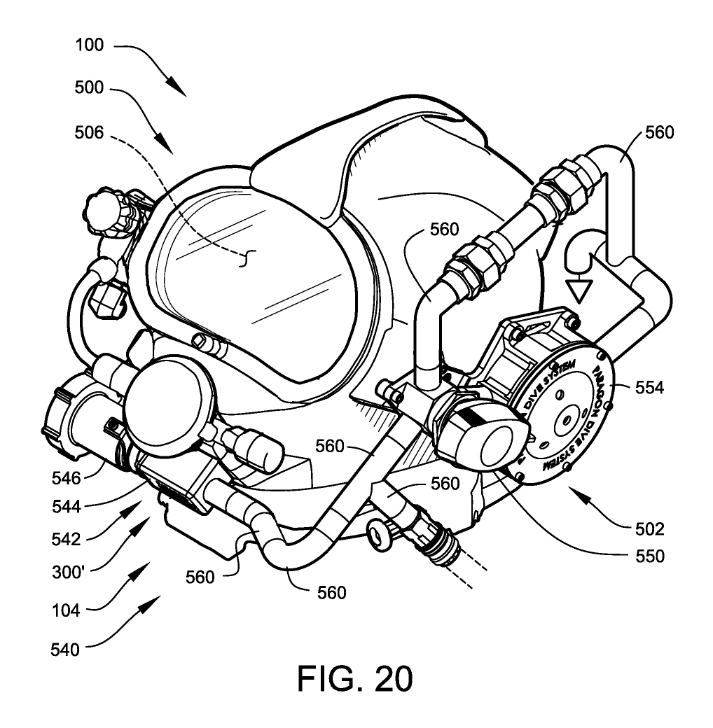

Implementations of HMRSEDS 300 can include “factory hardened” implementations, where no components are replaced but hardened components are original. The “factory-hardened” suits can include chemically hardened components and can be functionally similar to the modified dry suits described with respect to FIGS. 1C and 12. FIG. 20 shows a perspective view illustrating an example “factory-hardened” dive helmet to enhance diver safety. The dive helmet 500 can include physical arrangements similar or substantially similar to the post-retrofit implementations. The dive helmet 500 can be supplied in a ready-to-use “pre-hardened” configuration. The dive helmet 500 can include features of the diving equipment modifications, such as modifications made using the HEMA 120.

To increase diver safety, the dive helmet 500 can include a set of protective enhancements to improve diver protection from contaminants, such as toxic compounds such as marine diesel and jet fuel, biological compounds such as bacteria and biological warfare agents, and chemical warfare agents. The dive apparatus as disclosed can be designed to generate and maintain a fully-protected and isolated breathing environment during dive operations. Some implementations of the protective diving system 100, including HMRSEDS 300, can incorporate contaminant-resistant materials and physical configurations to limit or prevent the intrusion of hazardous materials. This can form a continuous protective barrier around the diver's breathing environment.

The HMRSEDS 300 can include an arrangement of components 502 configured to assist in forming a protected breathing environment during a dive operation. In some implementations, the components 502 can include a pre-configured dive helmet 500 and a surface-return assembly 542 that can be functionally equivalent to the previously-described surface-return assembly 142. Other protective equipment arrangements, such as the utilization of chemically hardened dry suit materials and implementation of suit exhaust valves that exhaust to the surface through a return umbilical, can also be provided.

The dive helmet 500 can include at least one continuous barrier 501 configured to limit the transmission of hazardous materials from the contaminated water and into the diver's protected breathing environment. A portion of barrier 501 can be formed by an outer shell 504 that defines at least one internal cavity 506 into which the diver's head and cervical anatomy can be situated. The outer shell 504 of the dive helmet 500 can be constructed using one or more materials that exhibit low transmissibility with respect to the hazardous materials, and can be configured to limit intrusion of hazardous quantities of hazardous materials into the breathing environment, thus reducing transmission of the hazardous materials through the outer shell 504.

In some implementations, the outer shell 504 can be constructed of stainless steel. In some implementations, the outer shell 504 can be constructed using one or more chemically-resistant polymers, which can include a chemically-resistant coating 130. In addition, soft-goods such as O-rings, diaphragms, seals, gaskets, etc. of the dive helmet 500 can include one or more fluoroelastomers, where the fluoroelastomers have carbon-to-carbon linkages as the foundation of their molecular structures. Moreover, some or all of the exposed sealants used in the dive helmet 500 can include a fluoroelastomer so as to reduce migration of hazardous quantities of hazardous materials into the breathing environment of the dive helmet 500.

The dive helmet 500 can be fitted with components corresponding to the RSE assembly 104, the surface-supplied breathing gas subsystem 112, and the surface-return assembly 142. In the example illustrated in FIG. 20, the RSE assembly 104 can include a helmet-mounted subassembly 540. The modified locations of the helmet-mounted subassembly 540 can reflect the optimization of the factory-supplied helmet as shown.

Some of the component arrangements of the helmet-mounted subassembly 540 can correspond or closely correspond to the helmet-mounted subassembly 140 of the prior-described implementation. Therefore, components of the helmet-mounted subassembly 540 can include an exhaust plenum 544, an emergency dump valve 546, a three-way bypass valve 550, a DER 554, etc. In addition, the helmet-mounted subassembly 540 can include a modified support plate 557 to support the DER 554 in a more lateral position relative to the outer shell 504. A plurality of connector fittings 560 can be employed to operably couple the various components within the gas supply and the exhaust flow path.

In factory-hardened implementations, the breathing-gas supply hose of supply umbilical 105 can include a chemically-resistant hose material configured to maintain the structural integrity of the breathing gas supply hose when in contact with a hazardous material. In some implementations, a surface-return hose 170 can also include a chemically-resistant material. Examples of such chemically-resistant materials can include FKM, Viton®, and Teflon®. In some implementations, the supply and return hoses can be hardened by wrapping, as previously described.

Although the foregoing disclosed systems, methods, apparatuses, processes, and compositions have been described in detail within the context of specific implementations for the purpose of promoting clarity and understanding, it will be apparent to one of ordinary skill in the art that there are many alternative ways of implementing foregoing implementations which are within the spirit and scope of this disclosure. Accordingly, the implementations described herein are to be viewed as illustrative of the disclosed inventive concepts rather than restrictively, and are not to be used as an impermissible basis for unduly limiting the scope of any claims eventually directed to the subject matter of this disclosure.

What is claimed is:

1. A protective diving system for isolating a diver operating in a diving environment, the system comprising:
a dive helmet system, wherein the dive helmet system comprises a dive helmet;
a dry suit system, wherein one or more components of the dry suit system comprises a fluoroelastomer, and wherein the dry suit system comprises:
a dry suit, and
a surface exhaust valve coupled to the dry suit; and
a return-surface exhaust assembly configured to exhaust gas from one or both of the dive helmet system and the dry suit system to a breathable atmosphere outside of the diving environment of the diver, wherein the surface exhaust valve is configured to receive gas from the dry suit and exhaust gas to the return-surface exhaust assembly.

2. The system of claim 1, wherein one or more components of the dive helmet system comprises a fluoroelastomer.

3. The system of claim 1, wherein the return-surface exhaust assembly comprises:
a surface-return hose to exhaust the gas to the breathable atmosphere; and
a demand exhaust regulator, wherein the demand exhaust regulator comprises a valve assembly for controlling the flow of the gas from one or both of the dive helmet system and the dry suit system to the surface-return hose.

4. The system of claim 3, wherein the valve assembly comprises an exhaust diaphragm, wherein the exhaust diaphragm is movable between a flow-blocking position to block passage of the gas to the surface-return hose and a flow-delivery position to enable passage of the gas to the surface-return hose.

5. The system of claim 4, wherein the exhaust diaphragm is movable between the flow-blocking position and the flow-delivery position by one of: exhalation of breathing gas from the diver or activation for release of gas from the surface exhaust valve.

6. The system of claim 4, wherein the valve assembly comprises a valve seat positioned between an inlet opening and an outlet opening of the demand exhaust regulator, wherein the valve seat comprises a plurality of gas-conducting passages to enable the flow of the gas from the inlet opening to the outlet opening when the exhaust diaphragm is in the flow-delivery position.

7. The system of claim 6, wherein each of the plurality of gas-conducting passages comprises a frustoconical aperture.

8. The system of claim 3, wherein the valve assembly is configured to control the flow of the gas on demand to maintain a substantially static equilibrium pressure within the dive helmet.

9. The system of claim 1, wherein the gas is exhausted through the return-surface exhaust assembly without exhausting the gas to the diving environment.

10. The system of claim 1, wherein the return-surface exhaust assembly is connected to the helmet diving system, and wherein the surface exhaust valve is coupled to the return-surface exhaust assembly via a return umbilical.

11. The system of claim 1, wherein the surface exhaust valve is configured to maintain a buoyancy of the diver by controlling the release of air from the dry suit to the return-surface exhaust assembly.

12. The system of claim 1, wherein the return-surface exhaust assembly comprises an emergency dump valve configured to relieve pressure upon over-pressurization inside the dive helmet.

13. The system of claim 1, wherein one or both of the dry suit and the surface exhaust valve comprises one or more sealants, the one or more sealants comprising a fluoroelastomer.

14. The system of claim 1, further comprising:
a surface-supplied air subsystem for supplying air to the dry suit; and
a surface-return assembly configured to receive the gas from the return-surface exhaust assembly and to exhaust the gas to the breathable atmosphere, wherein the surface-return assembly comprises:
at least one vacuum pump, and
at least one breathing-gas monitoring unit to monitor the exhausted gas.

15. A return-surface exhaust dry suit assembly system for isolating a diver operating in a diving environment, the system comprising:
a surface exhaust valve for coupling to a dry suit for the diver, wherein the surface exhaust valve comprises an inlet port for receiving gas from the dry suit and an exhaust port for exhausting the gas;
a return umbilical coupled to the exhaust port; and
a return-surface exhaust assembly coupled to the return umbilical and configured to exhaust the gas to a breathable atmosphere outside of the diving environment of the diver, wherein at least one of the surface exhaust valve, the return umbilical, and the return-surface exhaust assembly comprises a fluoroelastomer.

16. The system of claim 15, wherein the gas is exhausted through the return-surface exhaust assembly without exhausting the gas to the diving environment.

17. The system of claim 15, wherein the return-surface exhaust assembly comprises:
a surface-return hose to exhaust the gas to the breathable atmosphere; and
a demand exhaust regulator, wherein the demand exhaust regulator comprises a valve assembly for controlling the flow of the gas from the dry suit to the surface-return hose.

18. The system of claim 17, wherein the valve assembly comprises an exhaust diaphragm, wherein the exhaust diaphragm is movable between a flow-blocking position to block passage of the gas to the surface-return hose and a flow-delivery position to enable passage of the gas to the surface-return hose.

19. The system of claim 15, wherein the surface exhaust valve is configured to maintain a buoyancy of the diver by controlling the release of air from the dry suit to the return-surface exhaust assembly.

20. The system of claim 15, wherein at least one of the surface exhaust valve, the return umbilical, and the return-surface exhaust assembly comprises one or more sealants, the one or more sealants comprising a fluoroelastomer.
